(19) United States
(12) Patent Application Publication
(10) Pub. No.: US 2021/0146821 A1
(43) Pub. Date: May 20, 2021

(54) VEHICLE HEADLIGHT SYSTEM

(71) Applicant: LG Electronics Inc., Seoul (KR)

(72) Inventor: Jaehwan YOON, Seoul (KR)

(21) Appl. No.: 16/937,869

(22) Filed: Jul. 24, 2020

(30) Foreign Application Priority Data
Nov. 18, 2019 (KR) 10-2019-0147967

(51) Int. Cl. B60Q 1/06; G06K 9/00

(52) U.S. Cl. CPC B60Q 1/06; G06K 9/00798; B60Q 2300/42; B60Q 2300/322; B60Q 2300/324

(57) ABSTRACT

The present disclosure relates to a vehicle headlight system. According to the present disclosure, at least one of a self-driving vehicle (autonomous vehicle and autonomous driving), a user terminal, and a server is linked with an artificial intelligence (AI) module, an unmanned aerial vehicle (UAV), a robot, an augmented reality (AR) device, a virtual reality (VR) device, a device relating to 5G service, etc.

### CROSS-REFERENCE TO RELATED APPLICATIONS

This application claims the benefit of Korean Patent Application No. 10-2019-0147967, filed on Nov. 18, 2019, the entire contents of which is incorporated herein by reference for all purposes as if fully set forth herein.

### BACKGROUND

The present disclosure relates generally to a vehicle headlight system.

Generally, a vehicle is provided with a lighting function to allow a driver to see an object well in a driving direction at night driving, and a lighting device used for informing other vehicles or pedestrians of a driving status of the vehicle.

A headlight is a lighting device that functions to illuminate a path ahead of a vehicle.

A beam pattern implemented in the headlight of the vehicle includes a low beam mode and a high beam mode.

The low beam mode is designed such that light radiated from the headlight of the vehicle points below the horizon to limit the driver to see only roads near the vehicle. Thus, it is difficult for the driver to secure sufficient long-distance field of view (FOV) at night driving.

The high beam mode is designed such that light radiated from the headlight of the vehicle points over the horizon to secure the FOV of the driver so that the driver can see an object at a long distance. However, glare of the high beam mode may dazzle the driver of another vehicle in front of the vehicle.

The headlight is provided with an adaptive headlight system (AHS), so that glare affecting the driver of the vehicle in front may be prevented.

The AHS detects traffic conditions and a road environment by using a sensor such as a camera and then adjusts brightness and a radiation direction of the headlight, so that glare affecting the driver of vehicle in front may be prevented.

However, the AHS according to the related art adjusts brightness and a radiation direction of the headlight by using only information of the sensor such as the camera. Therefore, the conventional AHS may not recognize a vehicle at a long distance or may not be operated optimally when the vehicle travels on a curve.

### SUMMARY

Accordingly, the present disclosure has been made keeping in mind the above problems occurring in the related art, and the present disclosure is intended to propose a vehicle headlight system, wherein V2X (vehicle to everything) is used to recognize another vehicle that is far away and is difficult to be recognized by using a sensor such as a camera, and a high definition (HD) map is used to determine a driving path of the vehicle, so that the adaptive headlight system (AHS) is operated optimally in a specific situation.

In order to achieve the above object, according to one aspect of the present disclosure, there is provided a control method for an adaptive headlight system (AHS) controlling a headlight of a vehicle.

The control method for an adaptive headlight system (AHS) controlling a headlight of a vehicle according to an embodiment of the present disclosure includes: collecting driving information of a remote vehicle (RV) through V2X (vehicle to everything) communication; and determining AHS operational condition, wherein the AHS operational condition may be a condition in which a present location of the RV may be within an AHS operational range.

The AHS operational range may be determined on the basis of a radiation range of a headlight mounted to a host vehicle (HV).

The AHS operational range may be stored separately for each traffic lane in advance.

In the determining the AHS operational condition, it may be determined whether or not the present location of the RV is within the AHS operational range in response to a traffic lane where the RV is currently in.

Further, The control method for an adaptive headlight system (AHS) controlling a headlight of a vehicle according to an embodiment of the present disclosure may include: calculating a relative location of the RV by using a location of a host vehicle (HV) as a reference point.

Further, The control method for an adaptive headlight system (AHS) controlling a headlight of a vehicle according to an embodiment of the present disclosure may include: determining whether or not the RV drives in straight travelling.

Authenticity of straight travelling of the RV may be determined by checking an inclination value of each of coordinates in path history points of the RV.

Further, authenticity of straight traveling of the RV may be determined by checking a radius of curvature in path prediction information of the RV.

Further, The control method for an adaptive headlight system (AHS) controlling a headlight of a vehicle according to an embodiment of the present disclosure may include: determining whether or not the RV drives in an opposite direction to a host vehicle (HV).

Further, The control method for an adaptive headlight system (AHS) controlling a headlight of a vehicle according to an embodiment of the present disclosure may include: determining whether or not a location of the RV after a preset predetermined time is within the AHS operational range, when the RV does not drive in the straight travelling.

Further, The control method for an adaptive headlight system (AHS) controlling a headlight of a vehicle according to an embodiment of the present disclosure may include: determining whether or not the RV after the preset predetermined time drives in a opposite direction to a host vehicle (HV), when the location of the RV after the preset predetermined time is within the AHS operational range.

Further, The control method for an adaptive headlight system (AHS) controlling a headlight of a vehicle according to an embodiment of the present disclosure may include: receiving HD Map (high definition map) information; and on the basis of the HD Map information, radiating light of a headlight of a host vehicle (HV) toward an infrastructure, when a location of the infrastructure enters a radiation range of the headlight.

According to the present disclosure, an adaptive headlight system (AHS) controlling a headlight of a vehicle may include: a headlight configured to radiate light toward front of the vehicle; a communication device configured to collect driving information of a remote vehicle (RV); and a processor configured to determine AHS operational condition, wherein the AHS operational condition is a condition in which a present location of the RV is within an AHS operational range.

Further, adaptive headlight system (AHS) controlling a headlight of a vehicle may include: a memory in which the AHS operational range is stored, wherein the AHS operational range stored in the memory may be determined on the basis of a radiation range of the headlight mounted to a host vehicle (HV), and be stored separately for each traffic lane.

The processor may be configured to determine whether or not the present location of the RV is within the AHS operational range in response to a traffic lane where the RV is currently in.

The processor may be configured to calculate a relative location of the RV on the basis of a location of a host vehicle (HV).

The processor may be configured to determine whether or not the RV drives in straight travelling.

The processor may be configured to determine whether or not the RV drives in the straight traveling by checking an inclination value of each of coordinates in path history points of the RV.

The processor may be configured to determine whether or not the RV drives in the straight travelling by checking a radius of curvature in path prediction information of the RV.

The processor may be configured to determine whether or not the RV drives in an opposite direction to a host vehicle (HV).

When the RV is not in the straight travelling, the processor may determine whether or not a location of the RV after a preset predetermined time is within the AHS operational range.

When the location of the RV after the preset predetermined time is within the AHS operational range, the processor may determine whether or not the RV after the preset predetermined time drives in an opposite direction to a host vehicle (HV).

The communication device may be configured to receive HD Map (high definition map) information, and on the basis of the HD Map information, the processor may be configured to control light of the headlight of a host vehicle (HV) to be radiated toward an infrastructure, when a location of the infrastructure enters a radiation range of the headlight.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram showing an AI device according to an embodiment of the present disclosure;

FIG. 2 is a block diagram showing an AI server according to an embodiment of the present disclosure;

FIG. 3 is a block diagram showing an AI system according to an embodiment of the present disclosure;

FIG. 4 is a block diagram showing a wireless communication system to which methods proposed in the specification are applied;

FIG. 5 is a view showing an example of a method for transmitting and receiving a signal in the wireless communication system;

FIG. 6 is a view showing an example of a general operation between an autonomous-driving vehicle and the 5G network in the 5G system;

FIG. 7 is a view showing an example of an application operation between an autonomous-driving vehicle and the 5G network in the 5G system;

FIGS. 8 to 11 are flowcharts each showing an example of an operation of the autonomous-driving vehicle using the 5G.

FIG. 12 is a control block diagram of a vehicle according to an embodiment of the present disclosure;

FIG. 13 is a control block diagram of an autonomous-driving device according to an embodiment of the present disclosure;

FIG. 14 is a signal flowchart of an autonomous-driving vehicle according to an embodiment of the present disclosure;

FIG. 15 is a block diagram showing a control device of a headlight of a vehicle according to an embodiment of the present disclosure;

FIG. 16 is a flowchart showing a control method for the headlight of the vehicle according to an embodiment of the present disclosure;

FIG. 17 is a view showing an AHS operational range according to an embodiment of the present disclosure;

FIGS. 18 to 22 are views showing AHS operations according to an embodiment of the present disclosure;

FIG. 23 is a view showing a method for estimating a location and heading information of a vehicle after a preset predetermined time through path prediction in an intersection;

FIG. 24 is a flowchart showing a control method of a headlight of a vehicle according to another embodiment of the present disclosure; and

FIGS. 25 to 27 are views showing AHS operational control using infrastructure information of a HD Map according to an embodiment.

### DETAILED DESCRIPTION

Hereinbelow, exemplary embodiments of the present disclosure will be described in detail with reference to the accompanying drawings. Further, in the following description, if it is decided that the detailed description of known function or configuration related to the invention makes the subject matter of the invention unclear, the detailed description is omitted. Further, the accompanying drawings are only for easily understanding the embodiments, the technical spirits of the embodiments of are not limited by the accompanying drawings.

It will be understood that when an element (or area, layer, portion, etc.) is referred to as being “coupled” or “connected” to another element, it can be directly coupled or connected to the other element or intervening elements may be present therebetween.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

It will be understood that, although the terms first, second, etc. may be used herein to describe various elements, these elements should not be limited by these terms. These terms are only used to distinguish one element, from another element. For instance, a first element discussed below could be termed a second element without departing from the teachings of the present invention. Similarly, the second element could also be termed the first element. As used herein, the singular forms “a,” “an”, and “the” are intended to include the plural forms as well, unless the context clearly indicates otherwise.

<Artificial Intelligence (AI)>

In the specification, the AI refers to a field of researching an artificial intelligence or a methodology that can make the AI. Machine learning refers to a field of researching a methodology of defining various issues that the AI field covers and of solving the issues. Machine learning may be defined as an algorithm that improves performance of any work through steady experiences with respect to the work.

An artificial neural network (ANN) is a model used in machine learning, and may mean all of models consisting of artificial neurons (nodes) which form a network by connection of synapses, and having a problem solving skill. The ANN may be defined by a connection pattern between neurons of different layers from each other, a learning process updating model parameter, and an activation function generating an output value.

The ANN may include an input layer, an output layer, and selectively one or more hidden layers. Each layer includes one or more neurons, and the ANN may include a synapse between neurons. Each of neurons in the ANN may output a function value of an activation function with respect to input signals, a weighted value, and deflection that are input through the synapse.

The model parameter refers to parameter determined by learning, and includes the weighted value of the synaptic connections and deflection of neurons. Hyper-parameter refers to parameter that should be set in the machine learning algorithm before learning, and includes learning rate, the repeat count, mini-batch size, and initialization function.

A purpose of the learning of the ANN may be understood to determine the model parameter that minimizes a loss function. The loss function may be used as an indicator for determining the optimum model parameter in the learning process of the ANN.

Machine learning may be classified into the supervised learning, unsupervised learning, and reinforcement learning, on the basis of a learning method.

Supervised learning may refer to a learning method for the ANN in a state where a label with respect to learning data is provided, and the label may refer to a correct answer (or result value) that the ANN may estimate when the learning data is input to the ANN. The unsupervised learning may refer to a learning method for the ANN in a state where the label with respect to the learning data is not provided. The reinforcement learning may refer to a learning method for an agent defined in some environment to select action or an order of action that maximize accumulated compensation in each status.

In the ANN, machine learning that is realized by deep neural network (DNN) including multiple hidden layers may refer to deep learning, and deep learning is a part of machine learning. Hereinafter, machine learning is used as having a meaning including deep learning.

<Robot>

In the specification, a robot may refer to a machine that automatically processes or operates a given task by its own ability. In particular, a robot having a function of recognizing environment and determining by itself to operate may refer to an intelligent robot.

The robot may be classified into an industrial robot, a medical robot, a family robot, and a military robot, on the basis of purposes or fields of use.

The robot may be provided with a manipulator including an actuator or a motor to perform various physical operations such as a motion of moving joints of the robot. Further, a moveable robot may include a wheel, a brake, and a propeller to drive on the ground or to fly in the air.

<Autonomous-Driving (Self-Driving)>

In the specification, a vehicle may be an autonomous-driving vehicle. Autonomous-driving may refer to a technology of autonomous driving, and the autonomous-driving vehicle may refer to a vehicle that drives with minimum manipulation of a user or without manipulation of the user.

For example, the autonomous-driving may include a technology of maintaining a traffic lane where a vehicle drives in, a technology of automatically controlling a speed of a vehicle like adaptive cruise control, a technology of automatically travelling along a planned path, and a technology of automatically setting a path and travelling when a destination is set.

The vehicle may include all of a vehicle provided with only an internal combustion, a hybrid vehicle provided both of the internal combustion and an electric motor, and an electric vehicle provided only the electric motor. Further, the vehicle may include a train and a motorcycle in addition to a car.

At this point, the autonomous-driving vehicle may refer to a robot having a function of autonomous-driving.

<Extended Reality (XR)>

In the specification, extended reality is the general term for virtual reality (VR), augmented reality (AR), and mixed reality (MR). VR technology provides an object or a background in the real world as only computer graphic (CG) images, AR technology provides virtually made CG images being on real object images together, and MR technology is a CG technology of providing the real world and virtual objects by mixing and coupling to each other.

MR technology is similar to AR technology in view of showing a real object and a virtual object together. However, AR technology uses the virtual object in the form of supplementing the real object, but MR technology uses the virtual object and the real object as the same level.

XR technology may be applied to a head-mount display (HMD), a head-up display (HUD), a mobile phone, a tablet PC, a laptop computer, a desktop computer, a television, a digital signage, and the like. A device to which the XR technology is applied may refer to an XR device.

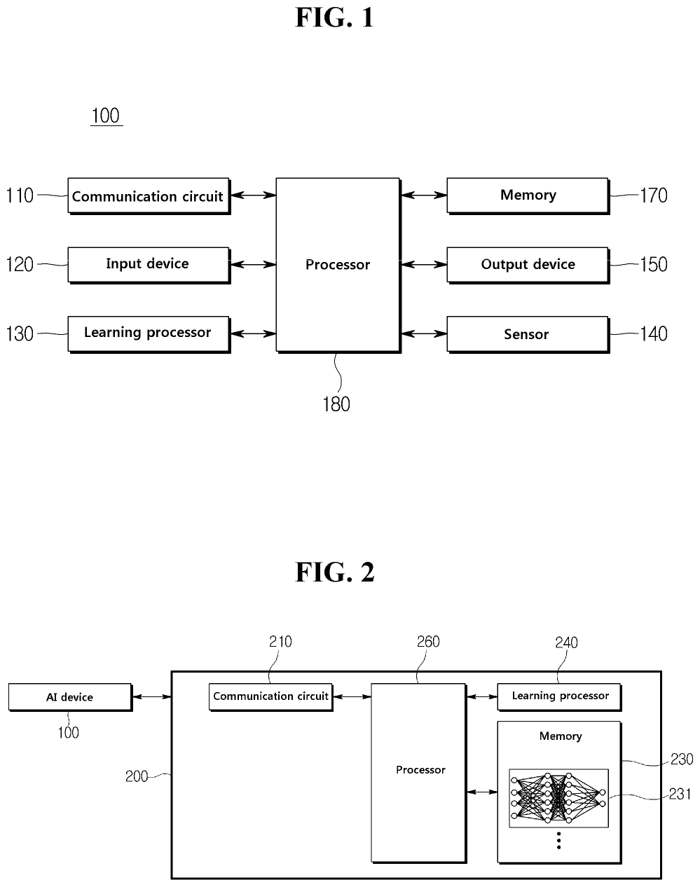

FIG. 1 is a block diagram showing an AI device according to an embodiment of the present disclosure.

The AI device 100 may be implemented as a fixed device or a moveable device, such as a television, a projector, a mobile phone, a smart phone, a desktop computer, a laptop computer, a digital broadcasting equipment, a personal digital assistant (PDA), a portable multimedia player (PMP), a navigation, a tablet PC, a wearable device, a set-top box (STB), a digital multimedia broadcasting (DMB) receiver, a radio, a washing machine, a refrigerator, a digital signage, a robot, a vehicle, and the like.

Referring to FIG. 1, the AI device 100 includes a communication circuit 110, an input device 120, a learning processor 130, a sensor 140, an output device 150, a memory 170, and a processor 180.

The communication circuit 110 may transmit or receive data to or from other AI devices 100a to 100e or an AI server 200 by using wired and wireless communication technology. For example, the communication circuit 110 may transmit and receive sensor information, a user input, a learning model, a control signal, and the like to or from external devices.

A communication technology used by the communication circuit 110 may be global system for mobile communication (GSM), code division multi access (CDMA), long term evolution (LTE), 5th generation mobile communication (5G), wireless LAN (WLAN), wireless-fidelity (Wi-Fi), Bluetooth™, radio frequency identification (RFID), infrared data association (IrDA), ZigBee, near field communication (NFC), and the like.

The input device 120 may obtain various types of data.

The input device 120 may include a camera for inputting an image signal, a microphone for receiving an audio signal, and a user input part for receiving information from the user. The camera or the microphone is considered a sensor, so signals obtained from the camera or the microphone may refer to sensing data or sensor information.

The input device 120 may obtain input data, which is used when output is obtained, by using learning data and learning model for model learning. The input device 120 may obtain raw input data, and in this case, the processor 180 or the learning processor 130 may extract an input feature on the input data as a pre-process.

The learning processor 130 may allow a model consisting of the ANN to learn by using the learning data. The learned ANN may refer to a learning model. The learning model may be used to estimate a resulting value for a new input data, not the leaning data. The estimated value may be used on a basis of determination for performing a specific operation.

The learning processor 130 may perform AI processing together with a learning processor 240 of the AI server 200.

The learning processor 130 may include a memory that is integrated or implemented in the AI device 100. Alternatively, the learning processor 130 may be implemented by using the memory 170, an external memory directly coupled to the AI device 100, or a memory maintained in an external device.

The sensor 140 may obtain at least one of internal information of the AI device 100, surrounding environment information of the AI device 100, and user information.

The sensor 140 may be a combination consisting of one or more of proximity sensor, illuminance sensor, acceleration sensor, magnetic sensor, gyro sensor, inertial sensor, RGB sensor, infrared (IR) sensor, finger scan sensor, ultrasonic sensor, optical sensor, microphone, lidar (light detection and ranging, LIDAR), radar (radio detection and ranging, RADAR), and the like.

The output device 150 may generate an output relating to sight, hearing, touch, or the like.

The output device 150 may include a display visually outputting information, a speaker audibly outputting information, and a haptic actuator tactilely outputting information. For example, the display may output an image and a video, the speaker may output voice or sound, and the haptic actuator may output vibration.

The memory 170 may store data that supports various functions of the AI device 100. For example, the memory 170 may store input data, learning data, learning model, and learning history, etc. that are obtained by the input device 120.

The memory 170 may include at least one storage medium of flash memory type memory, hard disk type memory, multimedia card micro type memory, card-type memory (for example, SD or XD memory), magnetic memory, magnetic disk, optical disc, random access memory (RAM), static random access memory (SRAM), read-only memory (ROM), programmable read-Only memory (PROM), and electrically erasable programmable read-only memory (EEPROM).

The processor 180 may determine at least one executable operation of the AI device 100 on the basis of information that is determined or generated by using a data analysis algorithm or the machine learning algorithm. The processor 180 may perform an operation that is determined by controlling components of the AI device 100.

For that, the processor 180 may request, retrieve, receive, or utilize data of the learning processor 130 or the memory 170, and may control the components of the AI device 100 to execute a predicted or desirable operation among the least one executable operation.

When the processor 180 needs to be linked to an external device in order to perform the determined operation, the processor 180 may generate a control signal for controlling the external device, and transfer the generated control signal to the external device.

The processor 180 may obtain intention information with respect to the user input and determine requirements of the user on the basis of the obtained intention information.

The processor 180 may intention information corresponding to the user input by using at least one of a speech to text (STT) engine for converting a voice input into a string or a natural language processing (NLP) engine for obtaining intention information of natural language.

At least one of the STT engine and the NLP engine may consist of the ANN at least partially learning according to the machine learning algorithm. Then, at least one of the STT engine and the NLP engine may learn by the learning processor 130, by the learning processor 240 of the AI server 200, or by distributed processing thereof.

The processor 180 may collect historical information including user's feedback about operation contents or operation of the AI device 100, and then store the information in the memory 170 or the learning processor 130, or transmit the information to the external device such as the AI server 200. The collected historical information may be used to update the learning model.

The processor 180 may control at least some of the components of the AI device 100 in order to run an application program stored in the memory 170. Moreover, the processor 180 may operate the components of the AI device 100 by combining two or more of the components included in the AI device 100.

FIG. 2 is a block diagram showing the AI server according to an embodiment of the present disclosure.

Referring to FIG. 2, the AI server 200 may be a device that allows the ANN to learn by using the machine learning algorithm or uses the learned ANN. The AI server 200 may consist of a plurality of servers to perform distributed processing, or may be defined as a 5G network. The AI server 200 may be included as a part of configuration of the AI device 100 to perform at least part of AI processing together with the AI device.

The AI server 200 may include a communication circuit 210, a memory 230, the learning processor 240, and the processor 260.

The communication circuit 210 may transmit and receive data to and from the external device such as the AI device 100.

The memory 230 may store a model during learning or learned (or the ANN, 231) through the learning processor 240.

The learning processor 240 may allow the ANN 231a to learn by using the learning data. The learning model may be used while being mounted to the AI server 200 of the ANN or being mounted to the external device such as the AI device 100.

The learning model may be implemented in a hardware, a software, or a combination of hardware and software. When a part or all of the learning model is implemented in software, one or more instructions constituting the learning model may be stored in the memory 230.

The processor 260 may estimate a result value with respect to new input data by using the learning model, and then generate a response or control command based on the estimated result value.

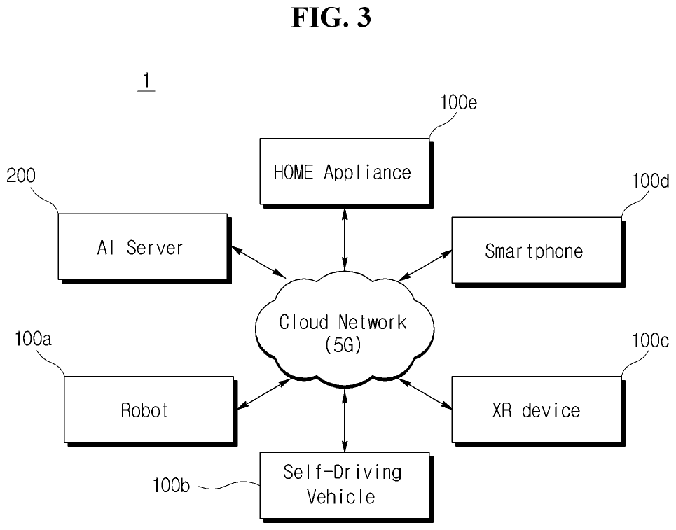

FIG. 3 is a block diagram showing an AI system according to an embodiment of the present disclosure.

Referring to FIG. 3, in the AI system 1, at least one of the AI server 200, a robot 100a, an autonomous-driving vehicle 100b, an XR device 100c, a smart phone 100d, and a home appliance 100e may be connected with a cloud network 10. The robot 100a, the autonomous-driving vehicle 100b, the XR device 100c, the smartphone 100d, and the home appliance 100e that apply the AI technology may refer to the AI device 100a to 100e.

The cloud network 10 may refer to a network constituting a part of a cloud computing infrastructure or being in the cloud computing infrastructure. The cloud network 10 may be configured by using a 3G network, a 4G or long term evolution (LTE) network, or a 5G network.

That is, each device 100a to 100e, and 200 constituting the AI system 1 may be connected to each other through the cloud network 10. In particular, each device 100a to 100e, and 200 may communicate with each other through a base station, but may also communicate with each other directly without the base station.

The AI server 200 may include a server performing the AI processing and a sever performing calculation about big data.

The AI server 200 may be connected with at least one of the robot 100a, the autonomous-driving vehicle 100b, the XR device 100c, the smartphone 100d, and the home appliance 100e, which are AI devices constituting the AI system 1, through the cloud network 10. Further, the AI server 200 may help at least some of the AI processing of the connected the AI device 100a to 100e.

The AI server 200 may allow the ANN to learn according to the machine learning algorithm on behalf of the AI device 100a to 100e, may directly store the learning model or transmit the learning model to the AI device 100a to 100e.

The AI server 200 may receive the input data from the AI device 100a to 100e, estimate a result value about the received input data by using the learning model, and generate response or control command based on the estimated result value then transmit the response or control command to the AI device 100a to 100e.

Alternately, the AI device 100a to 100e may directly use the learning model to generate a result value about the input data, and generate response or control command based on the estimated result value.

Hereinafter, various embodiments of the AI device 100a to 100e in which the above-described technologies are applied will be described. The AI devices 100a to 100e shown in FIG. 3 may refer to specific embodiments of the AI device 100 shown in FIG. 1.

<AI+Robot>

The robot 100a applies the AI technology, and may be implemented in a guide robot, carrying robot, cleaning robot, wearable robot, entertainment robot, pet robot, pilotless flying robot, and the like.

The robot 100a may include a robot control module for controlling operation, and the robot control module may refer to a software module or a chip in which the software module is implemented in hardware.

The robot 100a may use the sensor information obtained from various types of sensors to obtain status information of the robot 100a, to detect (recognize) surrounding environment and objects, to form map data, to determine a travel path and a driving plan, to determine response with respect to user interactions, or to determine an operation.

The robot 100a may use the sensor information obtained from at least one sensor of LiDAR, a radar, and a camera to determine the travel path and the driving plan.

The robot 100a may perform the above-described operation by using the learning model consisting of at least one ANN. For example, the robot 100a may recognize surrounding environment and objects by using the learning model, and may determine the operation by using information about the recognized surrounding environment or objects. The learning model may be a model learning directly in the robot 100a or in the external device such as the AI server 200.

The robot 100a may directly generate a result by using the learning model to perform the operation, but may be transmit the sensor information to the external device such as the AI server 200 and then receive a generated result therefrom to perform the operation.

The robot 100a may determine the travel path and the driving plan by using at least one of the map data, object information detected from the sensor information, or object information obtained from the external device. Then, the robot 100a may control a driving part to allow the robot 100a to drive along the determined travel path and driving plan.

The map data may include object identification information about various objects disposed in a space in which the robot 100a moves. For example, the map data may include the object identification information about fixed objects such as a wall and a door and movable objects such as a flower pot and a desk. Further, the object identification information may include name, type, location, and the like.

In addition, the robot 100a may perform the operation or may move by controlling the driving part on the basis of the user control/interaction. The robot 100a may obtain intention information of the user interaction according to a motion or voice utterance of the user, and determine response on the basis of the obtained intention information to perform the operation.

<AI+Autonomous-Driving>

The autonomous-driving vehicle 100b applies the AI technology, and may be implemented in a movable robot, a vehicle, and a pilotless plane.

The autonomous-driving vehicle 100b may include an autonomous-driving control module for controlling an autonomous-driving function. The autonomous-driving control module may refer to a software module or a chip in which the software module is implemented in hardware. The autonomous-driving control module may be included in the autonomous-driving vehicle 100b as configuration thereof, but may be connected to the autonomous-driving vehicle 100b by being provided as separate hardware outside the autonomous-driving vehicle 100b.

The autonomous-driving vehicle 100b may uses sensor information obtained from the various types of sensors to obtain status information of the autonomous-driving vehicle 100b, to detect (recognize) surrounding environment and objects, to form map data, to determine a travel path and a driving plan, or to determine an operation.

In order to determine the travel path and the driving plan, like the robot 100a, the autonomous-driving vehicle 100b may use the sensor information obtained from at least one sensor of LiDAR, a radar, and a camera.

In particular, the autonomous-driving vehicle 100b may recognize environment or objects in an area where the field of view is obscured or over a predetermined distance by receiving sensor information from the external devices, or may receive information from the external devices, the information being recognized by the external devices.

The autonomous-driving vehicle 100b may perform the above-described operation by using the learning model consisting of at least one or more of the ANN. For example, the autonomous-driving vehicle 100b may recognize surrounding environment and objects by using the learning model, and determine travel path by using information about the recognized surrounding environment or objects. The learning model may be a model learning directly in the autonomous-driving vehicle 100b or learns in the external device such as the AI server 200.

The autonomous-driving vehicle 100b may directly generate a result by using the learning model to perform the operation, but may be transmit the sensor information to the external device such as the AI server 200 and then receive a generated result therefrom to perform the operation.

The autonomous-driving vehicle 100b may determine the travel path and the driving plan by using at least one of the map data, object information detected from sensor information, or object information obtained from the external device. Then, the autonomous-driving vehicle 100b may control a driving part to allow the autonomous-driving vehicle 100b to drive along the determined travel path and driving plan.

The map data may include object identification information with respect to various objects disposed in a space (for example, road) in which the autonomous-driving vehicle 100b drives. For example, the map data may include the object identification information with respect to infrastructures such as a traffic sign, fixed objects such as a street light, a rock, and a building, and movable objects such as a vehicle and a pedestrian. Further, the object identification information may include name, type, distance, location, and the like.

In addition, the autonomous-driving vehicle 100b may perform the operation or may move by controlling the driving part on the basis of the user control/interaction. The autonomous-driving vehicle 100b may obtain intention information of the user interaction according to a motion or voice utterance of the user, and determine response on the basis of the obtained intention information to perform the operation.

<AI+XR>

The XR device 100c applies the AI technology, and may be implemented in a HMD, a HUD provided in a vehicle, a TV, a smartphone, a PC, a wearable device, a home appliance, a digital signage, a vehicle, a fixed or movable robot, and the like.

The XR device 100c may obtain information about surrounding spaces or real objects by analyzing three-dimensional point cloud data or image data obtained through the various sensors or the external device and then generating location data and attribute data for three-dimensional points, and may output an XR object which will be output by rendering the XR object. For example, the XR device 100c may output the XR object including additional information about the recognized object in correspondence with the recognized object.

The XR device 100c may perform the above-described operation by using the learning model consisting of at least one or more of the ANN. For example, the XR device 100c may recognize real objects from three-dimensional point cloud data or image data by using the learning model, provide information corresponding to the recognized real objects. The learning model may be a model learning directly in the XR device 100c or learns in the external device such as the AI server 200.

The XR device 100c may generate a result by using the learning model to perform the operation, but may be transmit sensor information to the external device such as the AI server 200 and the receive a generated result therefrom to perform the operation.

<AI+Robot+Autonomous-Driving>

The robot 100a applies the AI technology, and may be implemented in a guide robot, carrying robot, cleaning robot, wearable robot, entertainment robot, pet robot, pilotless flying robot, and the like.

The robot 100a to which the AI technology and the autonomous-driving technology are applied may refer to a robot itself having an autonomous-driving function or the robot 100a interacting with the autonomous-driving vehicle 100b.

The robot 100a having the autonomous-driving function may be a general term for devices that move themselves along a given moving line without user control or move by selecting themselves a moving line.

The robot 100a and the autonomous-driving vehicle 100b that have the autonomous-driving function may use a common sensing method so as to determine one or more of the travel path or the driving plan. For example, the robot 100a and the autonomous-driving vehicle 100b that have the autonomous-driving function may determine one or more of the travel path or the driving plan by using sensing information obtained by LiDAR, a radar, and a camera.

The robot 100a interacting with the autonomous-driving vehicle 100b may be separately provided from the autonomous-driving vehicle 100b. Further, the robot 100a may be linked with the autonomous-driving function at the inside or the outside of the autonomous-driving vehicle 100b, or perform an operation in conjunction with the user in the autonomous-driving vehicle 100b.

the robot 100a interacting with the autonomous-driving vehicle 100b obtains sensor information on behalf of the autonomous-driving vehicle 100b to provide the sensor information to the autonomous-driving vehicle 100b, or obtains sensor information and then generate surrounding environment information or object information to provide the information to the autonomous-driving vehicle 100b. Whereby, the robot 100a may control or help the autonomous-driving function of the autonomous-driving vehicle 100b.

Alternatively, the robot 100a interacting with the autonomous-driving vehicle 100b may control the function of the autonomous-driving vehicle 100b by monitoring the user in the autonomous-driving vehicle 100b or by interacting with the user. For example, when it is determined that a driver is in drowsy, the robot 100a may activate the autonomous-driving function of the autonomous-driving vehicle 100b or help the control of the driving part of the autonomous-driving vehicle 100b. The function of the autonomous-driving vehicle 100b which is controlled by the robot 100a may include not only the autonomous-driving function but a function provided by a navigation system or an audio system that are provided inside the autonomous-driving vehicle 100b.

The robot 100a interacting with the autonomous-driving vehicle 100b may provide information to the autonomous-driving vehicle 100b or assist with the function of the autonomous-driving vehicle 100b at the outside of the autonomous-driving vehicle 100b. For example, the robot 100a may provide traffic information including signal information to the autonomous-driving vehicle 100b like a smart traffic light, or may automatically connect an electric charger to a charging port by interacting with the autonomous-driving vehicle 100b like an automatic electric charger of an electric vehicle.

<AI+Robot+XR>

The robot 100a applies the AI technology and the XR technology, and may be implemented in a guide robot, carrying robot, cleaning robot, wearable robot, entertainment robot, pet robot, pilotless flying robot, drone, and the like.

The robot 100a to which the XR technology is applied may refer to a robot that is an object of control/interaction in an XR image. In this case, the robot 100a may be linked with the XR device 100c while being distinguished therefrom.

The robot 100a that is the object of control/interaction in the XR image operates such that, when the robot 100a obtains sensor information from the sensors including a camera, the robot 100a or the XR device 100c generates the an XR image based on the sensor information, and the XR device 100c may input the generated XR image. Further, the robot 100a may operate on the basis of a control signal input through the XR device 100c or interaction of the user.

For example, the user can check an XR image corresponding to the point of view of the robot 100a that is remotely linked with the XR device 100c through an external device such as the XR device 100c. Further the user can adjust an autonomous-driving path of the robot 100a, control operation or driving, or information of surrounding objects by using the interaction.

<AI+Autonomous-Driving+XR>

The autonomous-driving vehicle 100b applies the AI technology and the XR technology, and may be implemented in a movable robot, a vehicle, a pilotless plane, and the like.

The autonomous-driving vehicle 100b in which the XR technology is applied may refer to an autonomous-driving vehicle provided with a means providing XR images, or an autonomous-driving vehicle that is an object of control/interaction in XR images. In particular, the autonomous-driving vehicle 100b that is an object of control/interaction in XR images may be linked with the XR device 100 while being separated therefrom.

The autonomous-driving vehicle 100b provided with a means providing XR images may obtain sensor information from sensors including a camera, and may output XR images generated on the basis of the obtained sensor information. For example, the autonomous-driving vehicle 100b may provide an XR object corresponding to a real object or an object in a display to a passenger by being provided with a head-up display (HUD) and outputting the XR images.

When the XR object is output on the HUD, a part of the XR object may be output to overlap with the real object to which the passenger's eye moves. On the other hand, when the XR object is output on the display provided in the autonomous-driving vehicle 100b, a part of the XR object may be output to overlap with the object in the display. For example, the autonomous-driving vehicle 100b may output XR objects corresponding to an object such as a road, a remote vehicle, a traffic light, a traffic sign, a two-wheeled vehicle, a pedestrian, a building, and the like.

When the autonomous-driving vehicle 100b that is an object of control/interaction in XR images obtains sensor information from sensors including a camera, the autonomous-driving vehicle 100b or the XR device 100c may generate the XR images based on the sensor information, and the XR device 100c may output the generated XR images. Then, the autonomous-driving vehicle 100b may operate on the basis of a control signal input through an external device such as the XR device 100c or interaction of a user.

Hereinafter, a device requiring autonomous-driving information and/or 5th generation mobile communication (5G) required by the autonomous-driving vehicle.

<Operation of Autonomous-Driving Vehicle and 5G Network>

Example of Block Diagram of UE and 5G Network

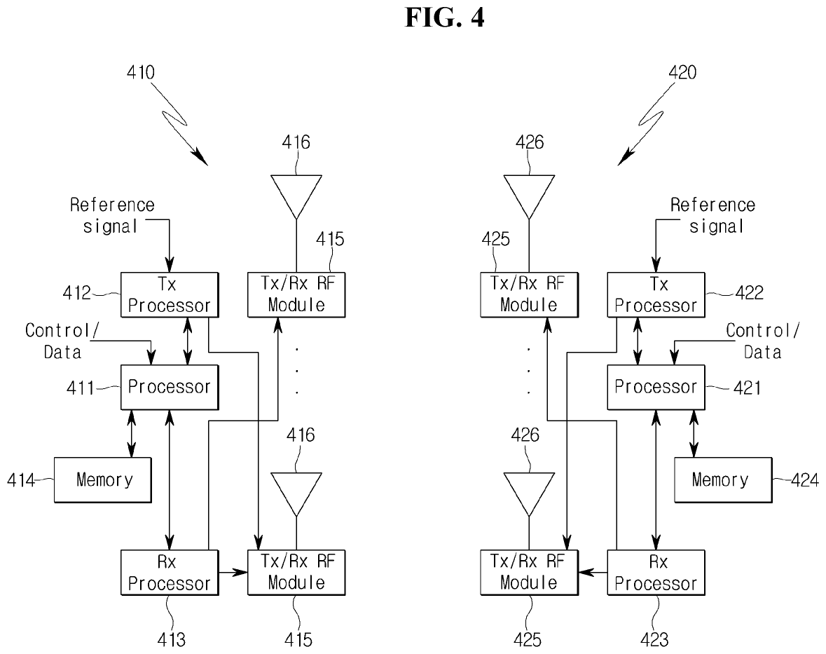

FIG. 4 is a block diagram showing a wireless communication system to which methods proposed in the specification are applied.

Referring to FIG. 4, a device including an autonomous-driving module (autonomous-driving device) refers to a first communication device (410 in FIG. 4), and a processor 411 may perform a detailed autonomous-driving motion.

The 5G network including another vehicle communicating with an autonomous-driving device refers to a second communication device (420 in FIG. 4), and a processor 421 may perform a detailed autonomous-driving motion.

The 5G network may refer to the first communication device, and the autonomous-driving device may be may refer to the second communication device.

For example, the first and second communication devices may be a base station, a network node, a transmission terminal, a receiving terminal, a wireless installation, a wireless communication device, an autonomous-driving device, and the like.

For example, a terminal or an user equipment (UE) may include a vehicle, a mobile phone, a smart phone, a laptop computer, a digital broadcasting terminal, a personal digital assistant (PDA), a portable multimedia player (PMP), a navigation, a slate PC, a tablet PC, an Ultrabook, a wearable device, such as a wristwatch-type terminal (smartwatch), a glass-type terminal (smart glass), a HMD, and the like. For example, the HMD may be a display device having a head-mounted form. For example, the HMD may be used to realize VR, AR, or MR. Referring to FIG. 4, the first communication device 410 and the second communication device 420 each include a processor 411 and 421, a memory 414 and 424, at least one Tx/Rx radio frequency (RF) module 415 and 425, a Tx processor 412 and 422, a Rx processor 413 and 423, an antenna 416 and 426. The Tx/Rx module may refer to a transceiver. Each Tx/Rx module 425 may transmit a signal through each antenna 426. The processor implements the above-described functions, processes, and/or methods. The processor 421 may be associated with the memory 424 storing a program code and data. The memory may refer to a computer readable medium. In more detail, in DL (communication from the first communication device to the second communication device), the TX processor 412 implements various signal processing functions with respect to a L1 layer (physical layer). The RX processor implements various signal processing functions with respect to the L1 layer (physical layer).

UL (communication from the second communication device to the first communication device) is processed in the first communication device 410 by a method similar to the description that is described with respect to the receiver in the second communication device 420. Each Tx/Rx module 425 receives a signal through each antenna 426. Each Tx/Rx module provides a carrier wave and information to the RX processor 423. The processor 421 may be associated with the memory 424 storing the program code and data. The memory may refer to a computer readable medium.

2. Signal Tx/Rx Method in Wireless Communication System

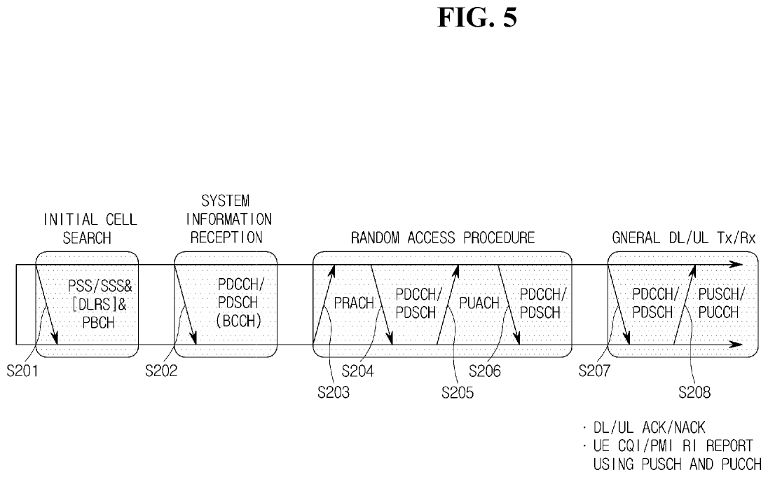

FIG. 5 is a view showing an example of a method for transmitting and receiving a signal in the wireless communication system.

Referring to FIG. 5, the UE performs initial cell search such as synchronization with BS when the UE is powered up or newly enters a cell (S201). In order to do that, the UE may receive a primary synchronization channel (P-SCH) and a secondary synchronization channel (S-SCH) from the BS to synchronize with BS and then obtain information such as a cell ID (Identifier). In an LTE system and an NR system, the P-SCH and the S-SCH are called a primary synchronization signal (PSS) and a secondary synchronization signal (SSS), respectively. After the initial cell search, the UE may receive a physical broadcast channel (PBCH) from BS to obtain broadcast information in the cell. Meanwhile, the UE may receive a downlink reference Signal (DL RS) in the initial cell search to check a state of a downlink channel. The UE after performing the initial cell search may obtain more specific system information by receiving a physical downlink shared Channel (PDSCH) according to a physical downlink control channel (PDCCH) and information included in the PDCCH (S202).

Meanwhile, when the UE accesses primarily to the BS or has no wireless resource for transmitting a signal, the UE may perform a random access procedure (RACH) with respect to the BS (S203 or S206). In order to do that, the UE may transmit a particular sequence as a preamble through a physical random access Channel (PRACH) (S203 and S205), and may receiving a message of random access response (RAR) with respect to the preamble through the PDCCH and the PDSCH corresponding thereto (S204 and S206). In a case of a contention-based RACH, further, a contention resolution procedure may be performed.

After the UE performs the above-described processes, the UE may receive the PDCCH/PDSCH (S207) as a general uplink/downlink signal transmission process and transmit a physical uplink shared Channel (PUSCH)/a physical uplink control channel (PUCCH) (S208). In particular, the UE receives a downlink control information (DCI) through the PDCCH. The UE monitors sets of PDCCH candidates from monitoring occasions set in at least one control element set (CORESET) on a serving cell according to search space configurations. The sets of the PDCCH candidates to be monitored by the UE may be defined by sides of search space sets, and a search space set may be a common search space set or an UE-specific search space set. The CORESET is configured of sets of (physical) resource blocks with a time duration of 1 to 3 OFDM symbols. The network may set the UE to have multiple CORESETs. The UE monitors the PDCCH candidates in one or more search space sets. Monitoring means attempting to decode the PDCCH candidates in one or more search space sets. When the UE succeeds in decoding one of the PDCCH candidates in one or more search space sets, the UE determines that PDCCH is detected in the PDCCH candidates, and performs PDSCH reception or PUSCH transmission on the basis of DCI in the detected PDCCH. The PDCCH may be used to schedule DL transmissions on the PDSCH and UL transmissions on the PUSCH. The DCI in the detected PDCCH includes: downlink assignment (that is, downlink grant; DL grant) including information about modulation, coding format, and resource allocation, which relate to the downlink shared channel; or uplink grant (UL grant) including information about modulation, coding format, and resource allocation, which relate to the uplink shared channel.

Procedures for initial access (IA) in 5G system will be further described with reference to FIG. 5.

The UE may perform a cell search, obtaining of system information, beam alignment for initial access, DL measurement on the basis of synchronization signal block (SSB). The SSB is used to be mixed with SS/PBCH (Synchronization Signal/Physical Broadcast channel) block.

The SSB is configured of the PSS, SSS, and PBCH. The SSB constituting four connected OFDM symbols, and transmits the PSS, PBCH, SSS/PBCH, or PBCH for each of the OFDM symbols. The PSS and SSS are configured of one OFDM symbol and 127 subcarriers, respectively, and the PBCH is configured of 3 OFDM symbols and 576 subcarriers.

The cell search means that the UE obtains cell time/frequency synchronization, and detects a cell ID of the cell (for example, Physical layer Cell ID, PCI). The PSS is used to detect the cell ID in a cell ID group, and the SSS is used to detect the cell ID group. The PBCH is used to detect a SSB (time) index and to detect a half-frame.

336 cell ID groups exist, and 3 cell IDs are provided for each cell ID group. Accordingly, total 1008 cell IDs exist. Information about a cell ID group to which a cell ID of a cell belongs is provided/obtained through the SSS of the cell, and information about the cell ID among the 336 cells in the cell ID is provided/obtained through the PSS.

The SSB is transmitted periodically along a SSB periodicity. When the initial cell search is performed, SSB basic periodicity that is assumed by the UE is defined as 20 ms. After the UE perform the cell access, the SSB periodicity may be set as one of 5 ms, 10 ms, 20 ms, 40 ms, 80 ms, and 160 ms by the network (for example, BS).

Next, system information (SI) reception will be described.

The SI is divided into a master information block (MIB) and a plurality of system information blocks (SIB). SI other than the MIB may refer to remaining minimum system information (RMSI). The MIB includes information/parameter for monitoring of the PDCCH scheduling the PDSCH carrying system information block 1 (SIB1), and is transmitted to the BS through the PBCH of the SSB. The SIB1 includes availability of the remaining SIBs (hereinafter, SIBx and x are an integer that is 2 or more) and information about the scheduling (for example, transmission periodicity and SI-window size). The SIBx is included in a SI message and is transmitted through the PDSCH. Each SI message is transmitted within the time-window periodically generated (that is, SI-window).

Random access (RA) procedure in the 5G system will be further described with reference to FIG. 5.

The RA procedure is used for various uses. For example, the RA procedure may be used for network initial access, handover, and UE-triggered UL data transmission. The UE may obtain UL synchronization and UL transmission resources through the RA procedure. The RA procedure is divided into a contention-based RA procedure and a contention-free RA procedure. The detailed procedure of the contention-based RA procedure will be described as follows.

The UE may transmit a RA preamble as Msg1 of the RA procedure in the UL through the PRACH. RA preamble sequences having different two lengths. A long sequence length of 839 is applied to subcarrier spacing of 1.25 and 5 kHz, and a short sequence length of 139 is applied to subcarrier spacing of 15, 30, 60, and 120 kHz.

When the BS receives the RA preamble from the UE, the BS transmits a message (Msg2) of a random access response (RAR) to the UE. The PDCCH scheduling the PDSCH carrying the RAR is transmitted by being CRC-masked as an RA radio network temporary identifier (RNTI)(RA-RNTI). The UE detecting the PDCCH masked as the RA-RNTI may receive the RAR from the PDSCH that is scheduled by the DCI carried by the PDCCH. The UE checks whether the preamble that is transmitted by itself, that is, RA response information about the Msg1 is in the RAR. Whether the RA information about the Msg1 transmitted by the UE exists may be determined by whether RA preamble ID with respect to the preamble transmitted by the UE exists. When the response about Msg1 does not exist, the UE may repeatedly transmit RACH preamble within the predetermined number of transmission while performing power ramping. The UE calculates PRACH transmission power with respect to the repeat-transmission of preamble on the basis of last path loss and power ramping counter.

The UE may transmit the UL on an uplink shared channel as an Msg3 of RA procedure on the basis of the RA response information. The Msg3 may include RRC connection request and an UE identifier. As a response to the Msg3, the network may transmit an Msg4, which refers to a contention solution message on the DL. As The Msg4 is received, the UE may enter in a RRC connected state.

3. General Operation by Using 5G Between Autonomous-Driving Vehicles

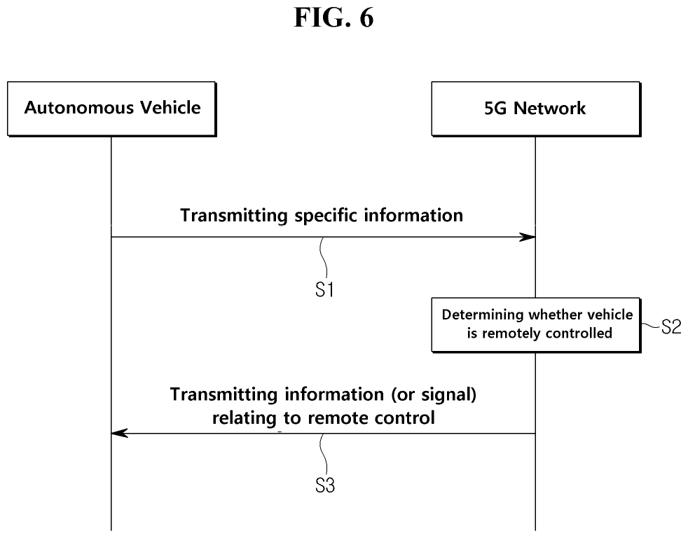

FIG. 6 is a view showing an example of a general operation between an autonomous-driving vehicle and 5G network in a 5G system.

The autonomous-driving vehicle (autonomous vehicle) perform transmission for specific information through the 5G network (S1).

The specific information may include autonomous-driving related information.

The autonomous-driving related information may be information that directly relates to the vehicle driving control. For example, the autonomous-driving related information may include one or more data of object data giving a direction to an object surrounding the vehicle, map data, vehicle status data, vehicle location data, and driving plan data.

The autonomous-driving related information may include service information and the like required for the autonomous-driving. For example, the specific information may include information with respect to a destination input through the user terminal and stability grade of the vehicle. Further, the 5G network may determine whether the vehicle is remotely controlled (S2).

The 5G network may include a sever or a module that performs remote control relating to the autonomous-driving.

Further, the 5G network may transmit information (or signal) that relates to the remote control to the autonomous-driving vehicle (S3).

As described above, the information relating to the remote control may be a signal applied directly to the autonomous-driving vehicle, or moreover, may include the service information required for the autonomous-driving. In the embodiment of the present disclosure, the autonomous-driving vehicle is configured to receive the service information such as insurance and risk section information for each section that is selected on a driving path through the server connected to the 5G network, thereby providing service relating to the autonomous-driving.

4. Application Operation Between Autonomous-Driving Vehicle and 5G Network in 5G System

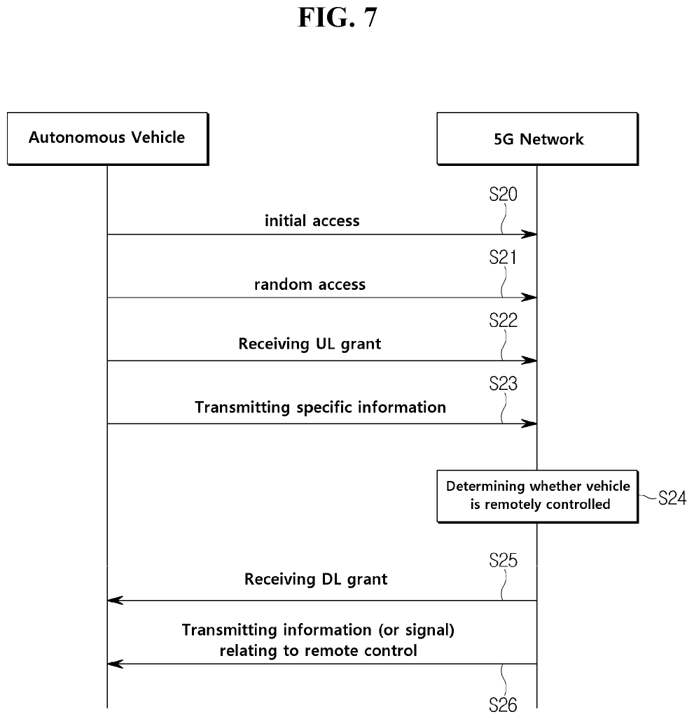

FIG. 7 is a view showing an example of an application operation between an autonomous-driving vehicle and 5G network in the 5G system 39.

The autonomous-driving vehicle performs the initial access procedure together with the 5G network (S20).

The initial access procedure includes a cell search procedure for obtaining downlink (DL) operation and a procedure for obtaining system information.

The autonomous-driving vehicle performs a random access (RA) procedure with the 5G network (S21).

The RA procedure includes a preamble transmission procedure and a RA response receiving procedure in order to obtain uplink (UL) synchronization or to transmit UL data, which will be described in a paragraph G in detail.

Further, the 5G network transmits UL grant for scheduling transmission for a specific information to the autonomous-driving vehicle (S22).

The receiving of UL Grant includes a procedure of receiving the time/frequency resource scheduling for transmitting the UL data to the 5G network.

Then, the autonomous-driving vehicle transmits specific information to the 5G network on the basis of the UL grant (S23).

Then, the 5G network determines whether the remote control of the vehicle is performed (S24).

The autonomous-driving vehicle receives the DL grant through the PDCCH in order to receive a response about the specific information from (S25).

The 5G network transmits information (or signal) relating to the remote control to the autonomous-driving vehicle on the basis of the DL grant (S26).

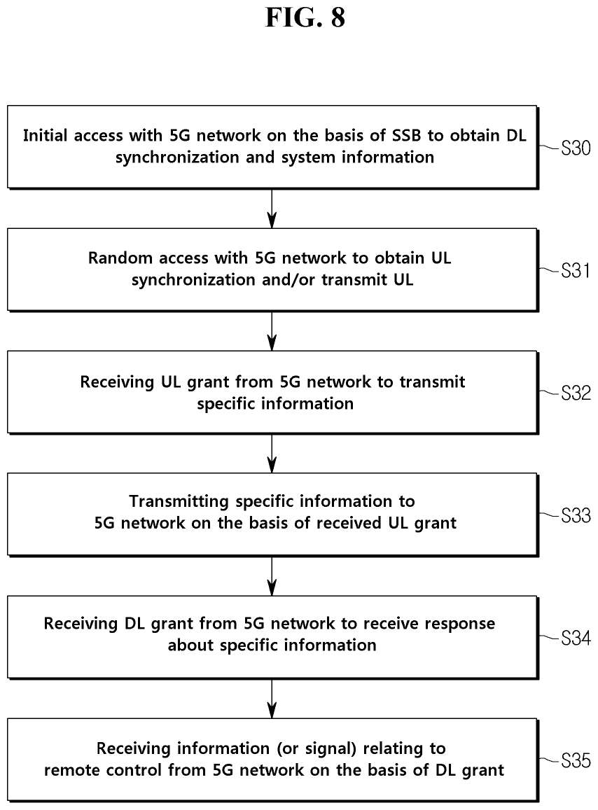

Meanwhile, as shown in FIG. 8, an example of combining the initial access procedure and/or the random access procedure between the autonomous-driving vehicle and the 5G network and the DL grant receiving procedure is illustrated in steps from S20 to S26, but the present disclosure is not limited thereto.

For example, the initial access procedure and/or the random access procedure may be performed through steps of S20, S22, S23, S24, and S24. Further, for example, the initial access procedure and/or the random access procedure may be performed through steps of S21, S22, S23, S24, and S26. Further, the procedure of combining the AI operation and the DL grant receiving procedure may be performed through steps of S23, S24, S25, and S26.

Further, in FIG. 7, operation of the autonomous-driving vehicle is illustrated in steps of S20 to S26, but the present disclosure is not limited thereto.

For example, the operation of the autonomous-driving vehicle may be performed such that S20, S21, S22, and S25 are selectively combined with S23 and S26. Further, for example, the operation of the autonomous-driving vehicle may be configured of S21, S22, S23, and S26. Further, for example, the operation of the autonomous-driving vehicle may be configured of S20, S21, S23, and S26. Further, for example, the operation of the autonomous-driving vehicle may be configured of S22, S23, S25, and S26.

FIGS. 8 to 11 are flowcharts each showing an example of the operation of the autonomous-driving vehicle using 5G.

First, referring to FIG. 8, the autonomous-driving vehicle including the autonomous-driving module performs the initial access procedure on the basis of a synchronization signal block (SSB) together with the 5G network to obtain the DL synchronization and the system information (S30).

The autonomous-driving vehicle performs the random access procedure together with the 5G network to obtain the UL synchronization and/or the UL transmission (S31).

The autonomous-driving vehicle receives UL grant from the 5G network to transmit the specific information (S32).

The autonomous-driving vehicle transmits the specific information to the 5G network on the basis of the UL grant (S33).

The autonomous-driving vehicle receives DL grant for receiving a response about the specific information from the 5G network (S34).

The autonomous-driving vehicle receives the information (or signal) relating to the remote control from 5G network on the basis of the DL grant (S35).

In S30, a beam management (BM) procedure may be further included, and a beam failure recovery procedure relating to physical random access channel (PRACH) transmission may be further included in S31. QCL relation with respect to a beam receiving direction of the PDCCH including the UL grant may be further included in S32, and QCL relation addition with respect to a beam transmission direction of physical uplink control channel (PUCCH)/physical uplink shared channel (PUSCH) which include the specific information may further included in S33. Further, QCL relation relating to a beam receiving direction of the PDCCH including the DL grant may be further included in S34.

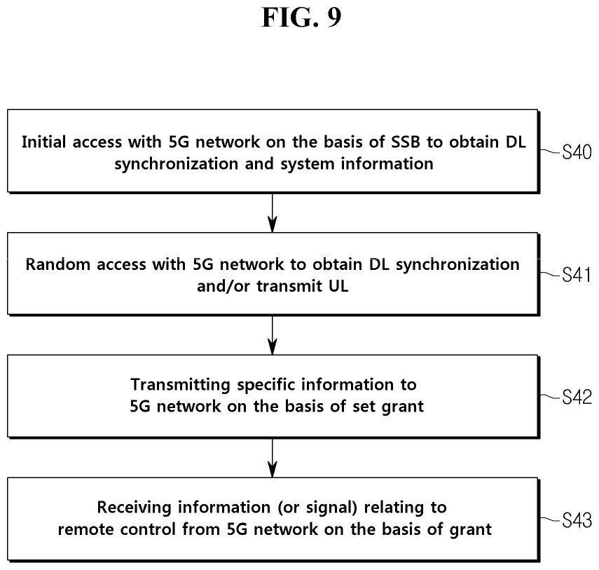

Referring to FIG. 9, the autonomous-driving vehicle performs the initial access procedure on the basis of the SSB together with the 5G network in order to obtain the DL synchronization and the system information (S40).

The autonomous-driving vehicle performs the initial access procedure together with the 5G network in order to obtain the UL synchronization and/or to transmit the UL (S41).

The autonomous-driving vehicle transmits specific information to the 5G network on the basis of a configured grant (S42). Instead of the procedure of performing the UL grant from 5G network, the configured grant will be described in a paragraph H in detail.

The autonomous-driving vehicle receives information (or signal) relating to the remote control from the 5G network on the basis of the configured grant (S43).

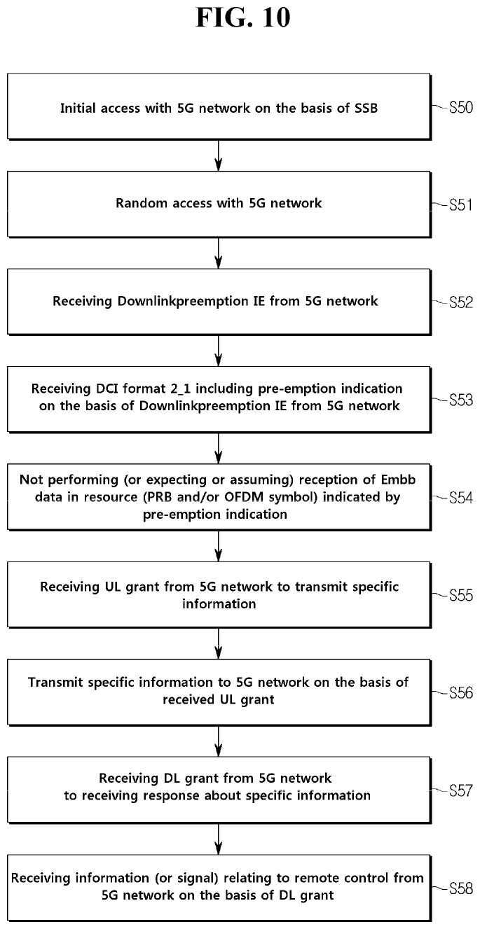

Referring to FIG. 10, the autonomous-driving vehicle performs the initial access procedure together with the 5G network on the basis of the SSB in order to obtain the DL synchronization and the system information (S50).

The autonomous-driving vehicle performs the random access procedure together with the 5G network in order to obtain the UL synchronization and/or to transmit the UL (S51).

The autonomous-driving vehicle receives DownlinkPreemption IE from the 5G network (S52).

The autonomous-driving vehicle receives a DCI format 2_1 including pre-emption indication from the 5G network on the basis of the DownlinkPreemption IE (S53).

The autonomous-driving vehicle does not perform (or expect or suppose) receiving of eMBB data from a resource (PRB and/or OFDM symbol) indicated by the pre-emption indication (S54).

Operation relating to the preemption indication may be described in a paragraph J in detail.

The autonomous-driving vehicle receives UL grant from the 5G network in order to transmit specific information (S55).

The autonomous-driving vehicle transmit the specific information to the 5G network on the basis of the UL grant (S56).

The autonomous-driving vehicle receives DL grant for receiving a response about the specific information from the 5G network (S57).

The autonomous-driving vehicle receives information (or signal) on the basis of the DL grant from the 5G network, the information relating to the remote control (S58).

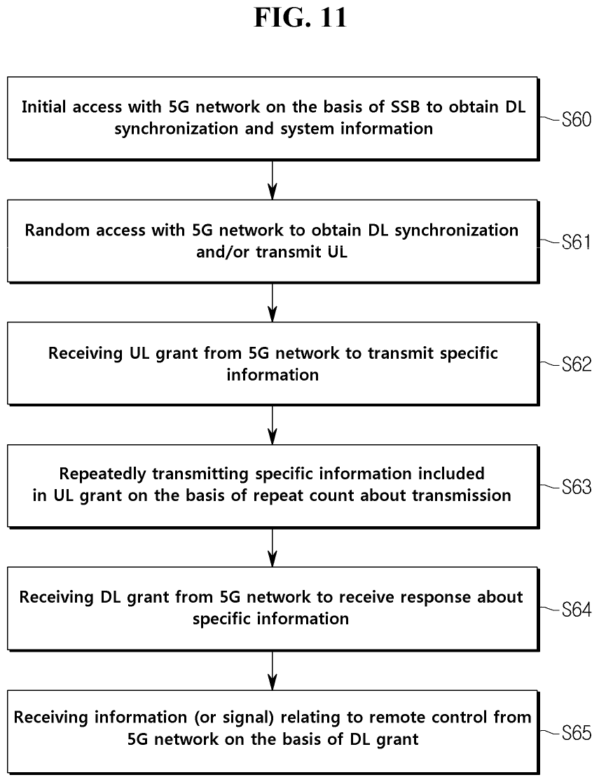

Referring to FIG. 11, the autonomous-driving vehicle performs the initial access procedure together with the 5G network on the basis of the SSB in order to obtain the DL synchronization and the system information (S60).

The autonomous-driving vehicle performs the random access procedure together with the 5G network in order to obtain the UL synchronization and/or to transmit the UL (S61).

The autonomous-driving vehicle receives UL grant from the 5G network in order to transmit specific information (S62).

The UL grant includes information about the repeat count of transmission of the specific information, and the specific information is transmitted repeatedly on the basis of the information about the repeat count (S63).

The autonomous-driving vehicle transmits the specific information to the 5G network on the basis of the UL grant.

The repeat transmission of the specific information is performed by frequency hopping, and transmission of a first specific information may be transmitted in a first frequency resource, and transmission of a second specific information may be transmitted in a second frequency resource.

The specific information may be transmitted in narrowband of 6 resource block (RB) or 1RB.

The autonomous-driving vehicle receives DL grant for receiving a response about the specific information from the 5G network (S64).

The autonomous-driving vehicle receives information (or signal) on the basis of the DL grant from the 5G network, the information relating to the remote control (S65).

The above-described 5G technology may be applied by being combined with methods proposed in the specification which will be described later, or may be added to definitize technical features of the methods proposed in the specification.

A vehicle described in the specification is connected to an external server through a communication network, and is moveable along a configured path without user intervention by using the autonomous-driving technology. The vehicle of the present disclosure may be implemented in an internal combustion vehicle provided with an engine as a power source, a hybrid vehicle provided with an engine and an electric motor as a power source, an electric vehicle provided with an electric motor as a power source, and the like.

In an embodiment hereinafter, a user may be interpreted as a driver, a passenger, or an owner of a user terminal. The user terminal may be a mobile terminal which is portable by a user and capable of executing phone call and various applications, for example, a smart phone, but is not limited thereto. For example, the user terminal may be interpreted as a mobile terminal, a personal computer (PC), a laptop computer, or an autonomous-driving vehicle system.

An autonomous-driving vehicle may be configured such that an accident occurrence type and frequency vary greatly depending on a capacity for sensing surrounding risk factors in real time. A path to a destination may include sections which have different risk levels due to various causes such as weather, topography, traffic congestion, and the like. The autonomous-driving vehicle of the present disclosure is configured to guide assurance required for each section when the user inputs a destination and updates assurance guidance by monitoring a danger section in real time.

At least one of the autonomous-driving vehicle, the user terminal, and the server of the present disclosure may be linked or converged with an AI module, an unmanned aerial vehicle (UAV), a robot, an AR device, a VR device, and a device relating to a 5G service.

For example, the autonomous-driving vehicle may be operated by being linked with at least one of the AI module and the robot that are included in the vehicle.

For example, the vehicle may interact with at least one robot. The robot may be an autonomous mobile robot (AMR) capable of driving by itself. The AMR may move freely since AMR is moveable by itself, and may drive while avoiding obstructions since the AMR provided with various sensors for avoiding obstructions during driving. The AMR may be an aerial robot provided with a flight device (for example, unmanned aerial vehicle, UAV). The AMR may be a robot that is provided at least one wheel and moves by rotation of the wheel. The AMR may be a leg-type robot that is provided with at least one leg and moves by using the leg.

The robot may function as a device supplementing accommodation of a vehicle user. For example, the robot may perform a function of transferring a load on a vehicle to a final destination of a user. For example, the robot may perform a function of guiding a user getting out of a vehicle to a final destination of the user. For example, the robot may perform a function of transferring a user getting out of a vehicle to a final destination of the user.

At least one electronic device included in a vehicle may be communicated with the robot through a communication device.

At least one electronic device included in a vehicle may provide data to the robot, the data being processed by the at least one electronic device included in a vehicle. For example, the at least one electronic device included in a vehicle may provide at least one of object data indicating objects surrounding a vehicle, map data, vehicle status data, vehicle location data, and driving plan data to the robot.

The at least one electronic device included in a vehicle may receive data processed by the robot from the robot. The at least one electronic device included in a vehicle may receive at least one data of sensing data generated by the robot, object data, robot status data, robot location data, and robot driving plan data.

The at least one electronic device in a vehicle may generate a control signal on the basis of the data received from the robot. For example, the at least one electronic device in a vehicle may compare information about objects, which is generated by an object detecting device, and information about objects, which is generated by the robot. Then, on the basis of a comparison result, the at least one electronic device in a vehicle may generate the control signal. The at least one electronic device in a vehicle may generate the control signal not to cause interference between a vehicle driving path and a robot driving path.

The at least one electronic device in a vehicle may include a software module or a hardware module for implementing AI (hereinafter, that refers to AI module). The at least one electronic device in a vehicle may input obtained data to the AI module, and use data that is output from the AI module.

The AI module may perform machine learning about the input data by using at least one artificial neural network (ANN). The AI module may output driving plan data through the machine leaning with respect to the input data.

The at least one electronic device in a vehicle may generate the control signal on the basis of the data output from the AI module.

According to an embodiment of the present disclosure, the at least one electronic device in a vehicle may receive data processed by AI from the external device through the communication device. The at least one electronic device in a vehicle may generate the control signal on the basis of the data processed by AI.

As an embodiment of the AI device 100, various embodiments with respect to a control method for the autonomous-driving vehicle 100b will be described. However, the embodiments described later are not limited as applications to only the autonomous-driving vehicle 100b, and may be applied to other AI devices 100a, and 100c to 100e without departing from the scope and spirit of the invention.

Components of Vehicle

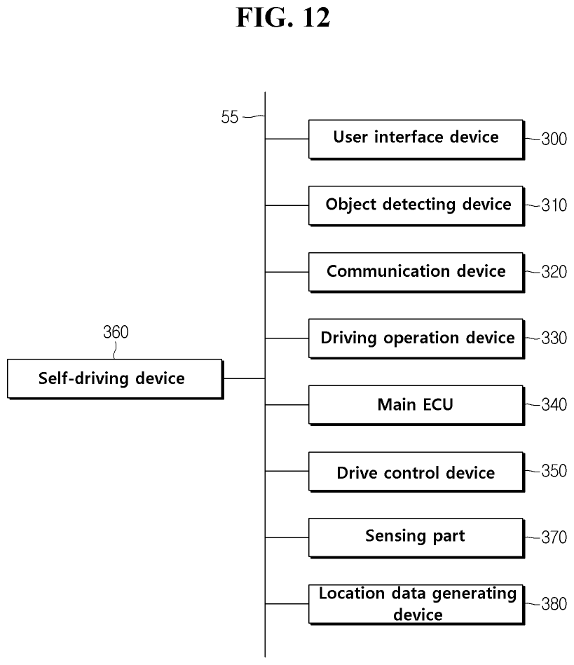

FIG. 12 is a control block diagram of a vehicle according to an embodiment of the present disclosure.

Referring to FIG. 12, the vehicle may include a user interface device 300, an object detecting device 310, a communication device 320, a driving operation device 330, a main electronic control unit (ECU) 340, a drive control device 350, an autonomous-driving device 360, a sensing part 370, and a location data generating device 380. The object detecting device 310, the communication device 320, the driving operation device 330, the main ECU 340, the drive control device 350, the autonomous-driving device 360, the sensing part 370, and the location data generating device 380 may be implemented in electronic devices that generate electrical signals, respectively, and exchange the electrical signals with each other.

1) User Interface Device

The user interface device 300 is a device for communication between a vehicle and a user. The user interface device 300 may receive a user input, and provide information generated in the vehicle to the user. The vehicle may implement user interface (UI) or user experience (UX) through the user interface device 300. The user interface device 300 may include an input device, an output device, and a user monitoring device.

2) Object Detecting Device

The object detecting device 310 may generate information about objects outside the vehicle. The information about objects may include at least any one of information about whether or not the objects exist, location information of the objects, distance information between the vehicle and the objects, and relative speed information between the vehicle and the objects. The object detecting device 310 may detect the objects outside of the vehicle. The object detecting device 310 may include at least one sensor capable of detecting the objects outside of the vehicle. The object detecting device 310 may include a camera, a radar, LiDAR, an ultrasonic sensor, and an infrared sensor. The object detecting device 310 may provide data about the objects, which is generated on the basis of a sensing signal generated from the sensor, to the at least one electronic device included in a vehicle.

2.1) Camera

A camera may generate information about an object outside a vehicle by using images. The camera may include at least one lens, at least one image sensor, and at least one processor that is electrically connected to the image sensor to process received signal from the image sensor, and then generates data about the object on the basis of the processed signal.

The camera may be at least one of a mono camera, a stereo camera, an around view monitoring (AVM) camera. The camera may obtain object location information, distance information between an object, or relative speed information with an object by using various image processing algorithm. For example, on the basis of variation of a size of an object, the camera may obtain the distance information between the object and the relative speed information with the object from the obtained image. For example, the camera may obtain the distance information between the object and the relative speed information with the object through a pin hole model, a road surface profiling. For example, the camera may obtain the distance information between the object and the relative speed information with the object on the basis of disparity information from stereo images obtained by the stereo camera.

The camera may be mounted to a position at a vehicle where a field of view (FOV) may be secured so as to capture an exterior of the vehicle. The camera may be disposed close to a front windshield in an interior of the vehicle so as to capture front images of the vehicle. The camera may be disposed around a radiator grill or a front bumper. The camera may be disposed closer to a rear glass in the interior of the vehicle so as to capture rear images of the vehicle. The camera may be disposed around a rear bumper, a trunk, or tailgate. The camera may be disposed close to at least any one of side windows in the interior of the vehicle so as to capture side images of the vehicle. Alternately, the camera may be disposed around side mirrors, fenders, or doors.

2.2) RADAR (Radio Detection and Ranging)

A RADAR (radar) may generate information about an object outside a vehicle by using radio wave. The radar may include an electromagnetic wave transmitter, an electromagnetic wave receiver, and at least one processor that is electrically connected with the electromagnetic wave transmitter and receiver to process a received signal, and then to generate data about an object on the basis of the processed signal. The radar may be implemented in a pulse radar method or a continuous wave radar method depending on a method of radio wave emission. In the continuous wave radar method, the radar may be implemented in a Frequency Modulated Continuous Wave (FMCW) method or a Frequency Shift Keying (FSK) method depending on a signal waveform. The radar may detect an object as a medium of the electromagnetic wave on the basis of a time of fight (TOF) method or a phase-shift method. Then, the radar may detect a location of the detected object, a distance between the detected object, and a relative speed with the detected object. The radar may be disposed at a proper position outside the vehicle to detect an object that is located at the front, the rear, or the side of the vehicle.

2.3) LIDAR (Light Detection and Ranging)

A LIDAR (lidar) may generate information about an object outside a vehicle by using laser light. The lidar may include an optical transmitter, an optical receiver, and at least one processor, the processor being electrically connected to the optical transmitter and the optical receiver to process a received signal, and on the basis of the processed signal, generating data about the object. The lidar may be implemented in a time of flight (TOF) type or a phase-shift type. The lidar may be implemented in a drive type or a non-drive type. In the case of the drive type, the lidar may be rotated by a motor and detect an object around the vehicle. In the case of the non-drive type, the lidar may detect an object by optical steering, the object being positioned within a predetermined range based on the vehicle. The vehicle 100 may include multiple non-drive type lidars. The lidar may detect the object as a medium of laser light, on the basis of the TOF method or the phase-shift method, and then detect a location of the detected object, a distance from the object, and a relative speed with the object. The lidar may be disposed at a proper position outside the vehicle so as to detect the object positioned at the front, the rear, the side of the vehicle.

3) Communication Device

The communication device 320 may exchange a signal with a device positioned outside the vehicle. The communication device 320 may exchange a signal with at least one of an infrastructure (for example, sever, broadcasting station), a remote vehicle, a terminal. The communication device 320 may include a transmitting antenna and a receiving antenna, which are provided for performing communication, and at least any one of a RF circuit and a RF element through which various communication protocols are implemented.

For example, the communication device may exchange a signal with the external device on the basis of the V2X technology. For example, the V2X technology may include LTE-based sidelink communication and/or NR-based sidelink communication. Further, the communication device may exchange information with an object such as a remote vehicle, a mobile device, and a road on the basis of the 5G network. A description relating to the V2X will be described later.

For example, the communication device may exchange a signal with an external device on the basis of the IEEE 802.11p PHY/MAC layer technology, the dedicated short range communications (DSRC) technology based on IEEE 1609 Network/Transport layer technology, or on the basis of standards of wireless access in vehicular environment (WAVE), SAE J2735, and SAE J2945. The DSRC (or WAVE standard) technology is a specification provided for providing an intelligent transport system (ITS) service through dedicated short range communication (DSRC) between vehicle mounted devices or between a roadside device and a vehicle mounted device. The DSRC technology may be a communication method that uses frequencies in 5.9 GHz band, and have a data transmission speed of 3 Mbps-27 Mbps. The IEEE 802.11p technology may be combined with the IEEE 1609 technology to support the DSRC technology (or WAVE standard).

The communication device of the present disclosure may exchange a signal with an external device by using any one of the V2X technology or the DSRC technology. Alternatively, the communication device of the present disclosure may exchange a signal with an external device by hybridizing the V2X technology and the DSRC technology. The V2X standard has been created through IEEE (Institute of Electrical and Electronics Engineers, IEEE 802.11p and IEEE 1609), and through SAE (Society of Automotive Engineers, SAE J2735 and SAE J2945), and IEEE and SAE are respectively responsible for physical layer, SW stack standardization, and application layer standardization. In particular, regarding a message standard, SAE has established standards for defining message specification for V2X communication.

4) Driving Operation Device

The driving operation device 330 is a device provided to receive a user input for driving. In a manual mode, a vehicle may drive on the basis of a signal provided by the driving operation device 330. The driving operation device 330 may include a steering input device (for example, steering wheel), an acceleration input device (for example, acceleration pedal), and a brake input device (for example, brake pedal).

5) Main ECU

The main ECU 340 may control overall operations of at least one electronic device provided in a vehicle.

6) Drive Control Device

The drive control device 350 is a device provided to electrically control various vehicle driving devices in a vehicle. The drive control device 350 may include a power train drive control device, a chassis drive control device, a door/window drive control device, a safety device drive control device, a lamp drive control device, and an air conditioning drive control device. The power train drive control device may include a power source drive control device and a transmission drive control device. The chassis drive control device may include a steering drive control device, a brake drive control device, and a suspension drive control device. Meanwhile, the safety device drive control device may include a safety belt drive control device for controlling a safety belt.

The drive control device 350 includes at least one electronic control device (for example, control ECU (electronic control unit)).

The drive control device 350 may control a vehicle drive device on the basis of a signal received from the autonomous-driving device 360. For example, the drive control device 350 may control a power train, a steering device, and a brake device on the basis of the signal received from the autonomous-driving device 360.

7) Autonomous-Driving Device

The autonomous-driving device 360 may generate a path for autonomous-driving on the basis of obtained data. The autonomous-driving device 360 may generate a driving plan for driving along the generated path. The autonomous-driving device 360 may generate a signal for controlling a motion of a vehicle based on the driving plan. The autonomous-driving device 360 may provide the generated signal to the drive control device 350.

The autonomous-driving device 360 may implement at least one advanced driver assistance system (ADAS) function. The ADAS may implement at least one system of adaptive cruise control (ACC), autonomous emergency braking (AEB), forward collision warning (FCW), lane keeping assist (LKA), lane change assist (LCA), target following assist (TFA), blind spot detection (BSD), adaptive headlight system (AHS), auto parking system (APS), PD collision warning system (PDCW), traffic sign recognition (TSR), traffic sign assist (TSA), night vision (NV), driver status monitoring (DSM), and traffic jam assist (TJA).

The autonomous-driving device 360 may perform a switching motion from an autonomous-driving mode to a manual-driving mode or a switching motion from the manual-driving mode to the autonomous-driving mode. For example, the autonomous-driving device 360 may change a mode of a vehicle from the autonomous-driving mode to the manual-driving mode or from the manual-driving mode to the autonomous-driving mode on the basis of a signal received from the user interface device 300.

8) Sensing Part

The sensing part 370 may sense a status of a vehicle. The sensing part 370 may include at least any one of an inertial measurement unit (IMU) sensor, a collision sensor, a wheel sensor, a speed sensor, an inclination sensor, a weight detection sensor, a heading sensor, a position module, a vehicle forward/rearward driving sensor, a battery sensor, a fuel sensor, a tire sensor, a steering sensor, a temperature sensor, a humidity sensor, an ultrasonic sensor, an illuminance sensor, and a pedal position sensor. Meanwhile, the IMU sensor may include at least one of an acceleration sensor, a gyro sensor, and a magnetic sensor.

The sensing part 370 may generate vehicle status data on the basis of a signal generated by at least one sensor. The vehicle status data may be information generated on the basis of data detected by various sensors provided inside the vehicle. The sensing part 370 may generate an electronics stability data, vehicle motion data, vehicle yaw data, vehicle roll data, vehicle pitch data, vehicle collision data, vehicle orientation data, vehicle angle data, vehicle speed data, vehicle acceleration data, vehicle inclination data, vehicle forward/rearward driving data, vehicle weight data, battery data, fuel data, tire pressure data, vehicle interior temperature data, vehicle interior humidity data, steering wheel turning angle data, vehicle exterior illuminance data, pressure data applied to an accelerator pedal, pressure data applied to a brake pedal, and the like.

9) Location Data Generating Device

The location data generating device 380 may location data of a vehicle. The location data generating device 380 may include at least one of global positioning system (GPS) and differential global positioning system (DGPS). The location data generating device 380 may generate the vehicle location data on the basis of a signal generated by at least one of the GPS and the DGPS. According to the embodiment, the location data generating device 380 may correct the location data on the basis of at least one of the IMU of the sensing part 370 and the camera of the object detecting device 310. The location data generating device 380 may refer to global navigation satellite system (GNSS).

The vehicle may include an internal communication system 55. A plurality of electronic devices included in the vehicle may exchange a signal with each other as a medium of the internal communication system 55. The signal may include data. The internal communication system 55 may use at least one communication protocol (for example, CAN, LIN, FlexRay, MOST, Ethernet).

Components of Autonomous-Driving Device

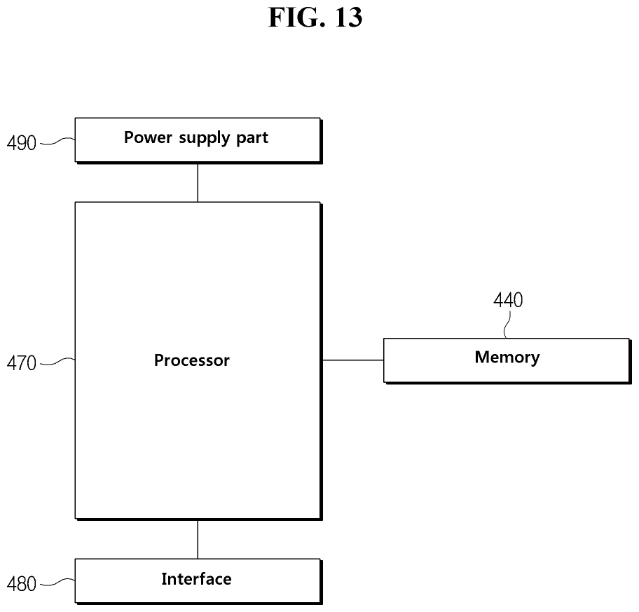

FIG. 13 is a control block diagram of an autonomous-driving device according to an embodiment of the present disclosure.

Referring to FIG. 13, the autonomous-driving device 360 may include a memory 440, a processor 470, an interface 480, and a power supply part 490.

The memory 440 is electrically connected with the processor 470. The memory 440 may store basic data about a unit, control data for motion control of the unit, and data to be input and output. The memory 440 may store data processed by the processor 470. The memory 440 may be configured as, as a hardware, at least any one of a ROM, a RAM, an EPROM, a flash drive, and a hard drive. The memory 440 may store a variety of data for overall operations of the autonomous-driving device 360, such as a program for processing or controlling the processor 470. The memory 440 may be implemented into an integral single body with the processor 470. According to the embodiment, the memory 440 may be classified into a sub-component of the processor 470.

The interface 480 may exchange a signal in wire and wireless manners with at least one electronic device provided in a vehicle. The interface 480 may exchange a signal in wire and wireless manners with at least any one of the object detecting device 310, the communication device 320, the driving operation device 330, the main ECU 340, the drive control device 350, the sensing part 370, and the location data generating device 380. The interface 480 may be configured of at least one of a communication module, a terminal, a pin, a cable, a port, a circuit, an element, and a device.

The power supply part 490 may supply power to the autonomous-driving device 360. The power supply part 490 may receive power from a power source (for example, battery) included in a vehicle, and supply the power to each unit of the autonomous-driving device 360. The power supply part 490 may be operated according to a control signal provided by the main ECU 340. The power supply part 490 may include a switched-mode power supply (SMPS).

The processor 470 may exchange a signal by being electrically connected with the memory 440, the interface 480, and the power supply part 490. The processor 470 may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performance of function.

The processor 470 may be driven by power provided by the power supply part 490. The processor 470 may receive data in a state where power is supplied by the power supply part 490 to the processor 470, process the data, generate a signal, and provide the signal.

The processor 470 may receive information from other electronic devices in the vehicle through the interface 480. The processor 470 may provide a control signal to other electronic devices in the vehicle through the interface 480.

The autonomous-driving device 360 may include at least one printed circuit board (PCB). The memory 440, the interface 480, the power supply part 490, and the processor 470 may be electrically connected to the PCB.

Operations of Autonomous-Driving Device

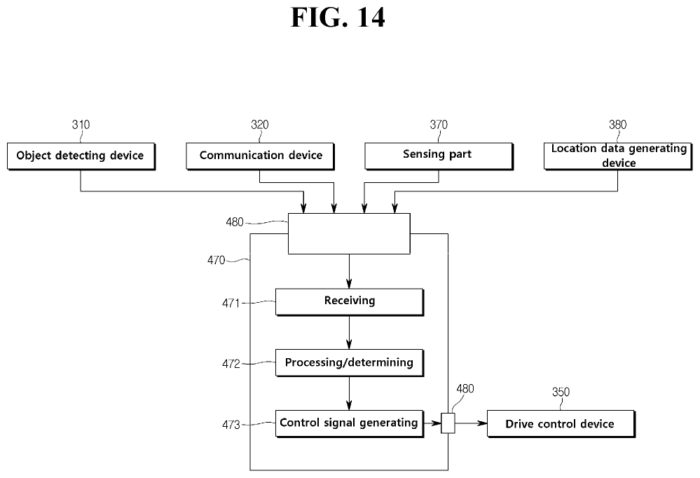

FIG. 14 is a signal flowchart of the autonomous-driving vehicle according to the embodiment of the present disclosure.

1) Receiving Operation

Referring to FIG. 14, the processor 470 may perform receiving operation. The processor 470 may receive data from at least one of the object detecting device 310, the communication device 320, the sensing part 370, and the location data generating device 380 through the interface 480. The processor 470 may receive object data from the object detecting device 310. The processor 470 may receive HD map data from the communication device 320. The processor 470 may receive vehicle status data from the sensing part 370. The processor 470 may receive location data from the location data generating device 380.

2) Processing/Determining Operation

The processor 470 may perform processing/determining operation. The processor 470 may perform the processing/determining operation on the basis of driving status information. The processor 470 may perform the processing/determining operation the basis of at least any one of the object data, the HD map data, the vehicle status data, and the location data.

The processor 470 may generate driving plan data. For example, the processor 470 may generate electronic horizon data. The electronic horizon data may be understood as driving plan data within a range from a point where the vehicle is positioned to horizon. The horizon may be understood as a point, based on a preset driving path, in front of a preset distance from the point where the vehicle is positioned. The horizon may be understood as a point where the vehicle may reach along the preset driving path after a predetermined time from the position where the vehicle is positioned.

The electronic horizon data may include horizon map data and horizon path data.

The horizon map data may include at least any one of topology data, road data, HD map data, and dynamic data. According to the embodiment, the horizon map data may include multiple layers. For example, the horizon map data may include a first layer matching the topology data, a second layer matching the road data, a third layer matching the HD map data, and a fourth layer matching the dynamic data. Further, the horizon map data may include static object data.

The topology data may refer to a map that is made by connecting centers of roads together. The topology data may be suitable for approximating a location of the vehicle, and may have a form of data used in navigation for a driver. The topology data may be understood as data about road information without traffic lane information. The topology data may be generated on the basis of data received from an external server through the communication device 320. The topology data may be based on data stored in at least one memory provided in the vehicle.

The road data may include at least any one of road inclination data, road curvature data, and load speed limit data. Further, the road data may include no overtaking section data. The road data may be based on the data received from the external server through the communication device 320 the communication device 320. The road data may be based on the data generated by the object detecting device 310.

The HD map data may include load topology information of detailed lane-level, connection information of each traffic lane, and specific information for vehicle localization (for example, traffic sign, Lane Marking/property, Road furniture, etc.). The HD map data may be based on the data received from the external sever through the communication device 320.

The dynamic data may include a variety dynamic information which may occur on roads. For example, the dynamic data may include construction information, variable speed traffic lane information, load surface condition information, traffic information, moving object information, and the like. The dynamic data may be based on the data received from the external server through the communication device 320. The dynamic data may be based on the data generated by the object detecting device 310.

The processor 470 may provide the map data within a range from a point where the vehicle is positioned to the horizon.

The horizon path data may refer to a track that the vehicle may obtain within the range from the point where the vehicle is positioned to the horizon. The horizon path data may include data indicating relative probability to select one road at a decision point (for example, forked road, junction, intersection, etc.). The relative probability may be calculated on the basis of the time taken to arrive at a final destination. For example, when at the decision point, when the time taken to reach the final destination on a first load is less than when the time with a second road, the probability of selecting the first load may be calculated to be higher than the probability of selecting the second road.

The horizon path data may include a main path and a sub path. The main path may be understood as a track connecting roads that have high relative probabilities of being selected. The sub path may branch at one or more decision points on the main path. The sub path may be understood as a track connecting at least one load that has a low relative probability of being selected at one or more decision points on the main path.

3) Control Signal Generating Operation

The processor 470 may perform control signal generating operation. The processor 470 may generate a control signal on the basis of the electronic horizon data. For example, the processor 470 may generate at least any one of a power train control signal, a brake device control signal, and a steering device control signal on the basis of the electronic horizon data.

The processor 470 may transmit the generated control signal to the drive control device 350 through the interface 480. The drive control device 350 may transmit the control signal to at least one of the power train, the brake device, and the steering device.

Hereinafter, detailed embodiments of the present disclosure will be described as follows.

Headlight Control Device for Vehicle

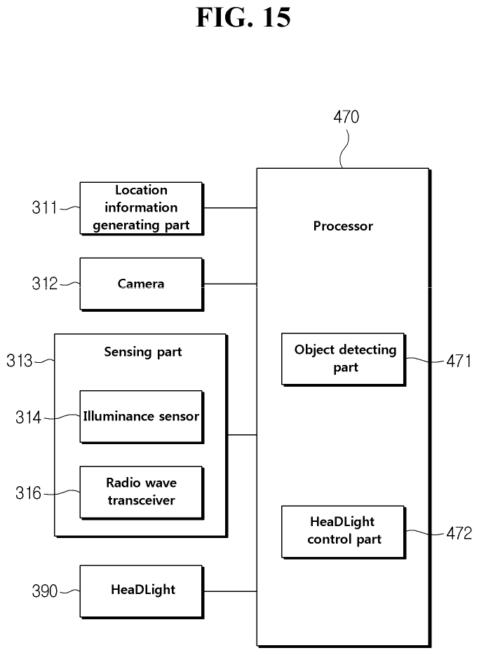

FIG. 15 is a block diagram showing a control device of a headlight of a vehicle according to an embodiment of the present disclosure. Each configuration shown in FIG. 15 may be the same as a part of the configuration shown in FIG. 12 or may be implemented similar thereto.

Referring to FIG. 15, a vehicle include the processor 470, a location information generating part 311, a camera 312, a sensing part 313, and a headlight 390.

The processor 470 oversees the ability to adjust illuminance of the headlight on the basis of the results of object detection. The processor 470 may include an object detecting part 471 involved in a series of actions for detecting an object and a headlight control part 472 controlling the headlight 390 depending on the detected object.

The location information generating part 311 may obtain location information (location coordinate) by using the GPS, and provide the obtained vehicle location information to the processor 470.

The camera 312 may obtain 2D or 3D images, and provide the images to the processor 470.

The sensing part 313 may include an illuminance sensor 314 acquiring ambient illuminance of the vehicle and a radio wave transceiver 316 detecting an object by suing radio waves. Further, the sensing part 313 may include an infrared camera (now shown) detecting an object by using infrared light.

The headlight 390 illuminates the front of the driving path in accordance with a control signal from the headlight control part 472. The headlight 390 may be implemented to adjust a direction in which light is radiated in accordance with the control signal. Further, the headlight 390 may be implemented to adjust brightness by varying illuminance in accordance with the control signal. Further, the headlight 390 may be implemented to adjust a range in which light is radiated in accordance with the control signal.

Control Method for Headlight of Vehicle

1) Anti-Glare for Other Vehicle Drivers

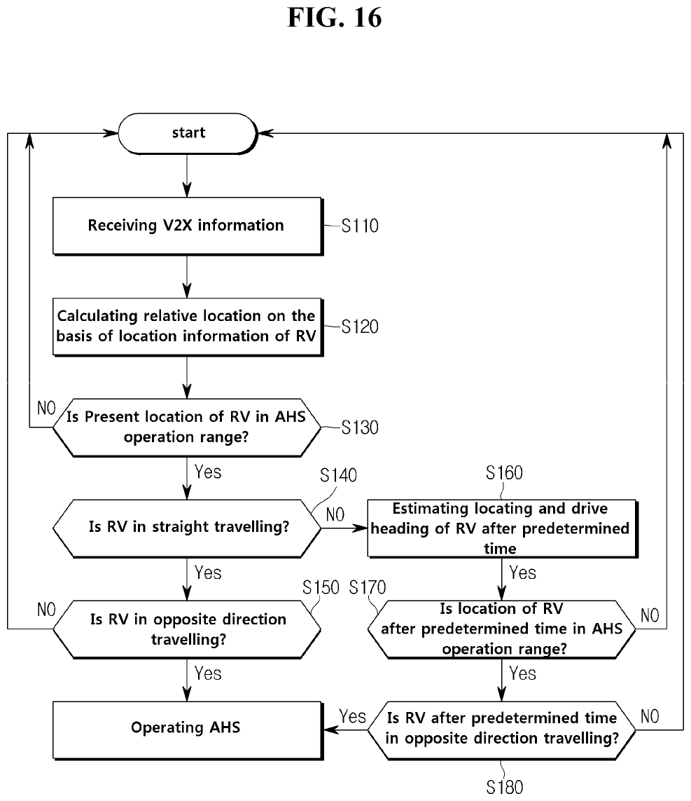

FIG. 16 is a flowchart showing a control method for a headlight of a vehicle according to an embodiment of the present disclosure.

The control method for a headlight of an autonomous-driving vehicle according to the embodiment of the present disclosure will be described with reference to FIG. 16 as follow.

In S110, the processor 470 receives driving information about a remote vehicle (RV) through information received from the communication device 320. The communication device 320 may exchange a signal with an external device of a vehicle by using the V2X technology. The external device may include the RV. The driving information about the RV may include information about time, location (3D Position, Position Accuracy), speed, heading, steering wheel angle, acceleration, brake status, vehicle size, eventflags, path history, path prediction, yaw rate, other optional fields, and the like.

Table 1 is an example of message information received from the RV through the V2X technology. The message information may include a variety of information in addition to the example in Table 1.

TABLE 1

| | |
|---|---|
| BSM Part1 | Latitude |
| | Longitude |
| | Heading |
| | YawRate |
| BSM Part2 | PathPrediction(Radius of Curvature) |
| | PathHistory(PH point delta X, Y info) |

Remote Vehicle LaneNum

In S120, the processor 470 calculates a relative location of the RV on the basis of a location of a host vehicle (HV). For example, the location of the HV may be marked by a starting point (0, 0), and the relative location of the RV may be marked by X and Y coordinates.

In S130, the processor 470 determines whether a present location of the RV exists within an AHS operational range. The AHS operational range may be stored in the memory 440 in advance. The AHS operational range may be determined on the basis of a radiation range of the headlight 390, and may be stored separately for each traffic lane. The radiation range of the headlight 390 may vary with a headlight model, so that the AHS operational range may be stored separately in the memory 440 for each the headlight 390 model.

Since the AHS operational range is stored separately for each traffic lane, the amount of computation required to determine the AHS operational range by the processor 470 may be reduced. As a result, a processing speed when the processor 470 determines the AHS operational range may be increased.

In S130, the processor 470 determines whether the present location of the RV exists within the AHS operational range. When the present location of the RV exists within the AHS operational range (YES), the processor 470 determines whether the RV drives in straight travelling, in S140. As a result of determination in S130, when the present location of the RV does not exist within the AHS operational range (NO), the processor 470 returns to the start of the headlight control, and the AHS is not operated.

In S140, the processor 470 determines whether the RV drives in the straight travelling. The processor 470 receives information about the RV through the information received from the communication device 320. The information about the RV may include heading, path history, and path prediction. The processor 470 may determine whether the RV drives in the straight travelling by checking an inclination value of each of coordinates of path history points. Further, when radius of curvature of the RV path prediction information is 32767, the processor 470 may determine that the vehicle drives in the straight travelling.

In S140, when the result of determining whether the RV drives in the straight travelling is that the RV drives in in the straight travelling (YES), the processor 470 determines whether the RV drives in a facing direction (opposite direction) to the HV, in S150.

In S150, whether the RV drives in the facing direction may be determined by calculating difference between HV heading information and RV heading information by the processor 470. The HV heading information may be checked by receiving the information from a heading sensor of the sensing part 370. The RV heading information may receive RV information through information received from the communication device 320, and the RV information may include heading, path history, and path prediction. When the difference in the heading information is 180 (degree), the HV and the RV drive in opposite directions. However, in consideration of an error range, when the difference between the HV heading information and the RV heading information is 170 or more, the processor 470 may determine whether the RV drives in an opposite direction to the HV.

As a result of determining in S140, when the RV does not drives in the straight travelling (NO, curve travelling), the processor 470 estimates a location and a drive heading of the RV after a predetermined time, in S160.

In S160, the processor 470 may estimate the location and a drive heading of the RV after the predetermined time through the path prediction information.

In S170, the processor 470 determines whether a location of the RV after the preset predetermined time is within the AHS operational range. As a result of determining in S170, when the location of the RV is within the AHS operational range (YES), the processor 470 determines whether the RV after the predetermined time drives in an opposite direction to the HV, in S180. In S180, whether the RV drives in the opposite direction to the HV may be determined such that the processor 470 calculates the difference between the HV heading information and the RV heading information, in the same method as the method in S150.

As a result of determining in S170, when the location of the RV is not within the AHS operational range (NO), the processor 470 returns to the start of the headlight control, and the AHS is not operated.

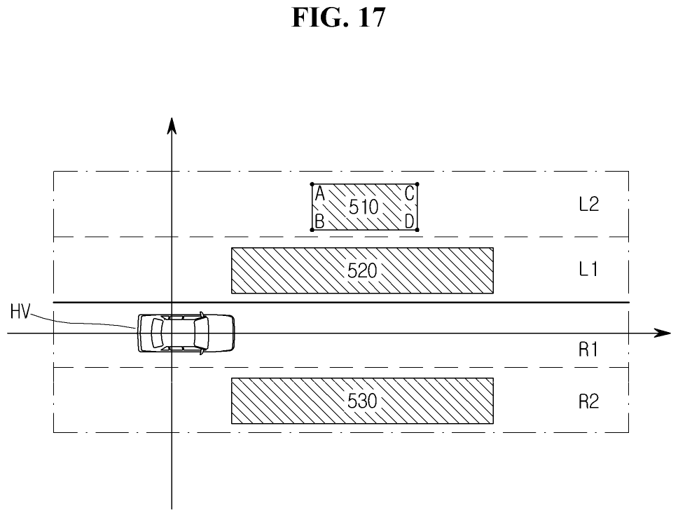

FIG. 17 is a view showing the AHS operational range according to an embodiment of the present disclosure.

Referring to FIG. 17, the AHS operational range may be marked as relative coordinates based on a location of the HV, the location of the HV being considered as a starting point (0,0). Traffic lanes are named L1, L2, . . . in order starting from an area near the left side of the HV, and named R1, R2, . . . in order starting from an area near the right side thereof. The AHS operational range may be a first area 510 in a traffic lane L2, a second area 520 in a traffic lane L1, and a third area 530 in a traffic lane R2. In FIG. 17, the AHS operational range has a long rectangular shape for each traffic lane, but this is for convenience of explanation only, and the embodiment of the present disclosure is not limited thereto. The first area 510 may be a long rectangle with four corners of A, B, C, and D. Locations of the four corners of A, B, C, and D may be marked by coordinates. For example, A may be marked at (10,10), B may be marked at (10,6), C may be marked at (15,6), and D may be marked at (15,10). The second area 520 and the third area 530 may also, as in the first area 510, define the AHS operational range such that the locations of the four corners are marked by coordinates, respectively.

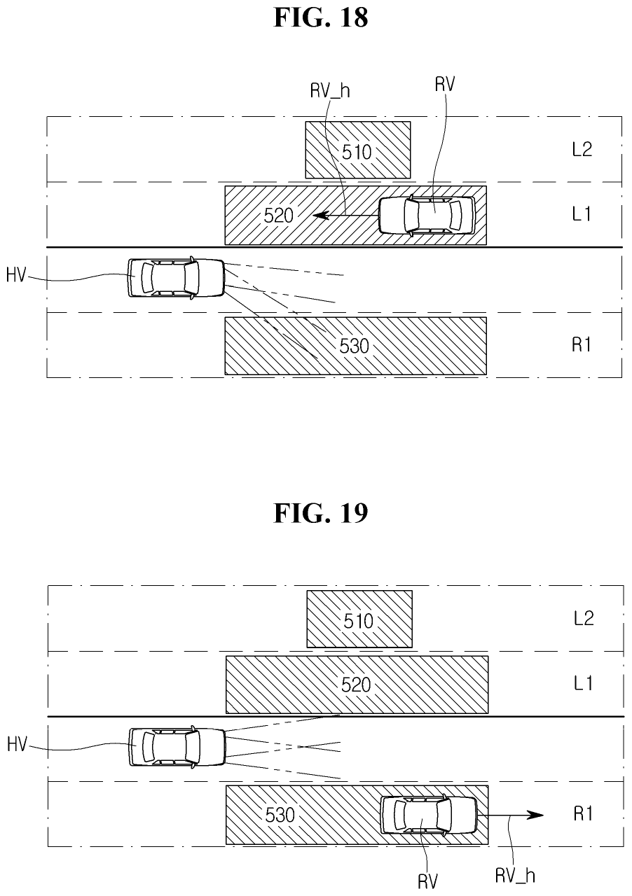

FIG. 18 is a view showing AHS operation according to an embodiment of the present disclosure.

In FIG. 18, a present location of the RV is within the AHS operational range 520. An arrow RV_h of the RV may indicate a drive heading of the RV. Referring to FIG. 18, the AHS operational range includes the first area 510, the second area 520, and the third area 530. The processor 470 determines whether a present location of the RV is within the AHS operational range S130. Then, the processor 470 determines whether the RV drives in the straight travelling S140.

The AHS operational range is stored as the first area 510, the second area 520, and the third area 530 by being separated for each traffic lane. The location of the RV is in the L1 traffic lane. In S130, the processor 470 performs determination of the AHS operational range, but there is not necessary to determine whether the location of the RV is in the AHS operational range with respect to the first area 510 of the L2 traffic lane and the third area 530 of the R1. In S130, when the processor 470 determines the AHS operational range, the processor 470 determines whether the location of the RV is only in the second area 520, which corresponds to the L1 traffic lane where the RV positioned. Accordingly, since the AHS operational range according to the embodiment of the present disclosure is stored separately for each traffic lane, the amount of computation can be reduced when the processor 470 determines the AHS operational range. As a result, a processing speed when the processor 470 determines the AHS operational range may be increased.

In a next step, the processor 470 determines whether the RV drives in the opposite direction to the HV (S150), and then operates the AHS. In FIG. 18, the processor 470 determines that the RV drives in the opposite direction to the HV, and thus operates the AHS, and the processor 470 adjusts a radiation direction of the headlight to the right to prevent glare of a driver of the front RV.

FIG. 19 is a view showing AHS operation according to an embodiment of the present disclosure.

In FIG. 19, a present location of the RV is within the AHS operational range 520 as in FIG. 8. An arrow RV_h of the RV indicates a drive heading of the RV. Referring to FIG. 19, unlike in FIG. 18, the location of the RV is within the third area 530. As described above, when the processor 470 determines the AHS operational range, the processor 470 determines whether the location of RV is only in the third area 530 corresponding to the R1 traffic lane where the RV is positioned. The processor 470 determines whether the RV drives in the opposite direction to the HV (S150), in FIG. 19, since the RV drives on the R1 traffic lane in the same direction as the HV not the opposite direction (S150, NO), the processor 470 does not operate the AHS.

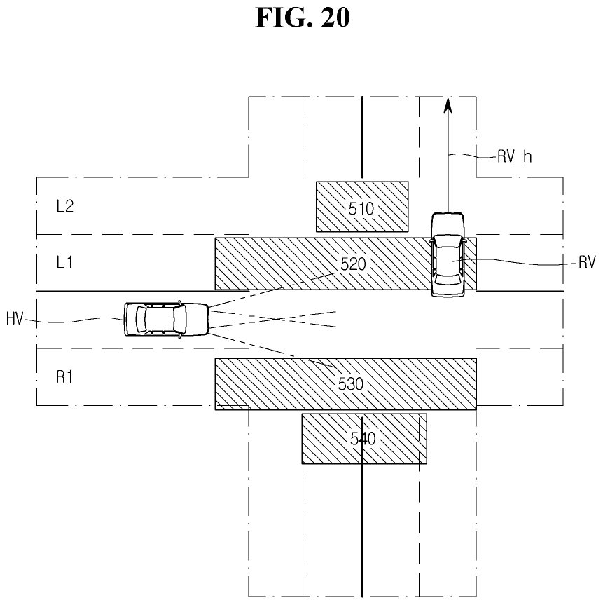

FIG. 20 is a view showing AHS operation according to an embodiment of the present disclosure.

FIG. 20 shows a situation in an intersection, and an arrow RV_h of the RV indicates a drive heading of the RV. A present location of the RV is in the AHS operational range 510 and 520. The processor 470 determines whether the RV drives in the opposite direction to the HV (S150), and in FIG. 20, since the RV drives in a perpendicular direction to the HV, not the opposite direction (S150, NO), the processor 470 does not operate the AHS. When the difference in the heading information is 90, the HV and the RV drive in the perpendicular direction to each other. However, in consideration of an error range, when the difference between the HV heading information and the RV heading information is from 80 to 100, the processor 470 may determine that the RV drives in the perpendicular direction to the HV.

However, when the RV drives in the perpendicular direction to the HV, optionally, the processor 470 may control to operate the AHS. This is because, depending on a radiation intensity of a headlight mounted to a vehicle, the field of view of a driver of the RV is obstructed by the headlight radiated toward the side of the RV.

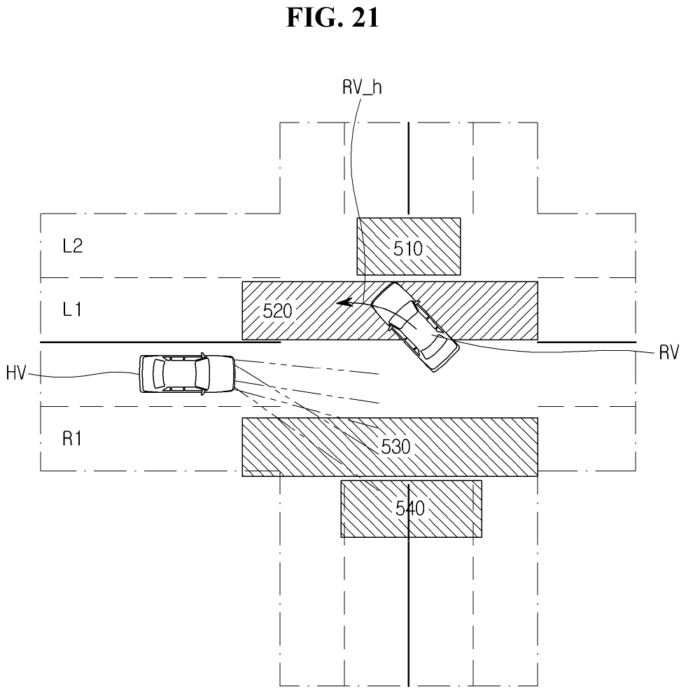

FIG. 21 is a view showing AHS operation of an embodiment of the present disclosure.

FIG. 21 shows a situation in an intersection, and an arrow RV_h of the RV indicates a drive heading of the RV. In FIG. 21, the RV drives in the curve travelling (left turn) in the intersection, unlike in FIG. 20. The processor 470 determines that the RV does not drive in the straight travelling (S140, NO), and estimates a location and a drive heading of the RV after a predetermined time (S160). The processor 470 may estimate the location and the drive heading of the RV after the preset predetermined time by using the Path Prediction information.

Then, the processor 470 determines whether a location of the RV after the preset predetermined time is in the AHS operational range (S170). As shown in FIG. 21, the location of the RV after the preset predetermined time is in the second area 520 that is the AHS operational range.

Then, the processor 470 determines whether the RV after the preset predetermined time drives in the opposite direction to the HV (S180), and in FIG. 21, the RV drives after performing the left turn drives in the opposite direction to the HV.

In FIG. 21, the processor 470 determines that the RV drives in the opposite direction to the HV, and thus operates the AHS. Accordingly, the processor 470 adjusts the radiation direction of a headlight to the right to prevent the glare of the driver of the front RV.

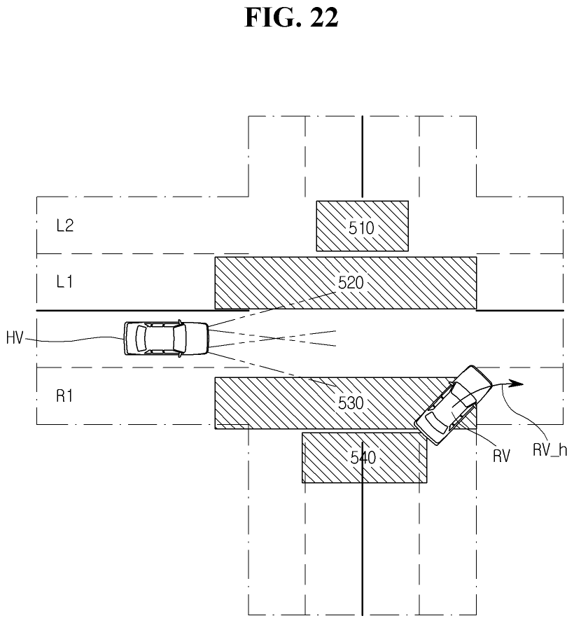

FIG. 22 is a view showing AHS operation according to an embodiment of the present disclosure.

FIG. 22 shows a situation in an intersection, an arrow RV_h of a RV indicates a drive heading of the RV. In FIG. 22, the RV drives while turning right in the intersection, unlike in FIG. 21. As described in FIG. 21, the processor 470 determines that the RV does not drive in the straight travelling (S140, NO), and estimates a location and a drive heading of the RV after the predetermined time (S160). The processor 470 may estimate the location and the drive heading of the RV after the preset predetermined time by using the path prediction information.

Then, the processor 470 determines whether the location of the RV after the preset predetermined time is in the AHS operational range (S170). As shown in FIG. 22, the location of the RV after the preset predetermined time is positioned in the third area 530 in the AHS operational range.

Then, the processor 470 determines whether the RV after the preset predetermined time drives in the opposite direction to a HV (S180). In FIG. 22, since the RV turns to the right, the RV drives on the R1 traffic lane in the same direction as the HV, not the opposite direction (S180, NO), the processor 470 does not operate the AHS.

FIF. 23 is a view showing a method of estimating a location and a drive heading of a vehicle after a preset predetermined time through the path prediction in an intersection.

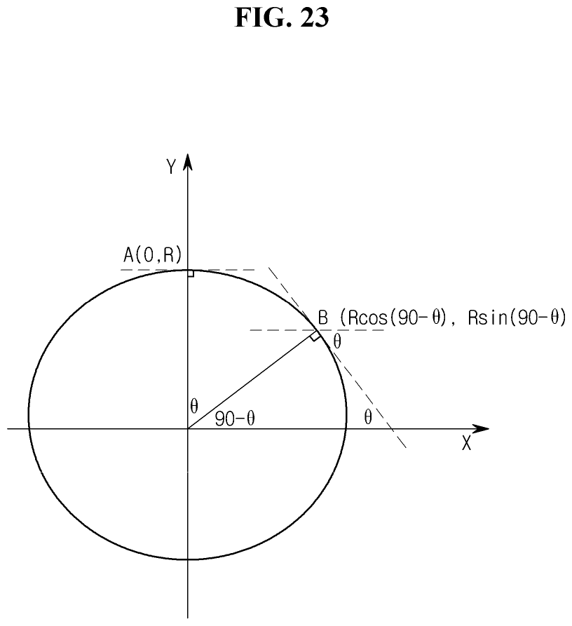

In FIG. 23, a radius R of a circle means a value of radius of curvature of the path prediction. As and =yaw rate, yaw rate information about a RV may be received through the V2X communication. The processor 470 may estimate the location and the drive heading of the RV after the preset predetermined time. A location coordinate of the RV may be marked at (R cos (90-), R sin (90-)). The processor 470 may determines, on the basis of estimating information about the location and the drive heading of the RV after the preset predetermined time, as in the case of straight travelling, whether the RV is in the AHS operational range, and the drive direction of the RV is opposite to a drive direction of a HV.

2) Radiation of Infrastructure

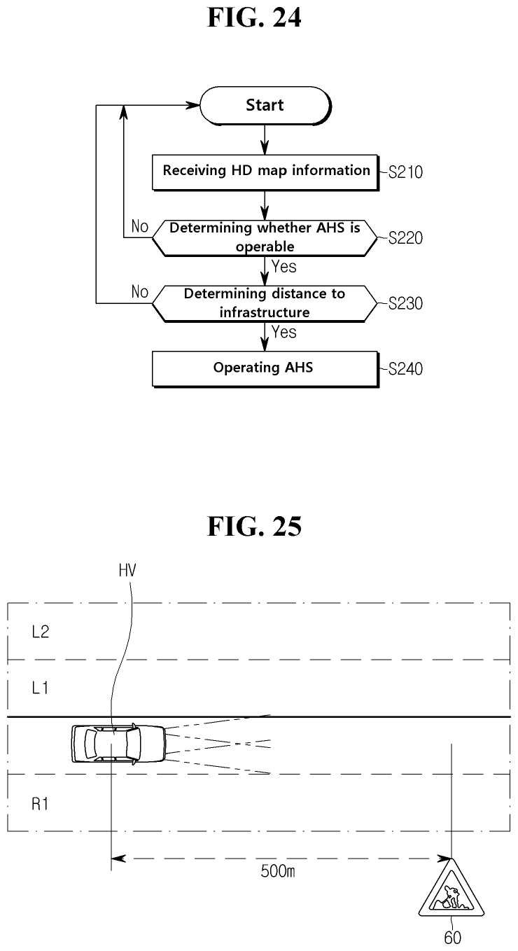

FIG. 24 is a flowchart showing a headlight control method of a vehicle according to another embodiment of the present disclosure.

Hereinafter, a headlight control method for an autonomous-driving vehicle according to an embodiment of the present disclosure will be described with reference to FIG. 24.

In S210, the processor 470 receives the HD map information through information received from the communication device 320.

The HD map data may include object identification information about various objects on a space (for example, road) where the autonomous-driving vehicle 100b drives. For example, the map data may include the object identification information including fixed objects such as infrastructure such as traffic sign, street lights, rocks, buildings, and the like and moveable objects such as vehicles, pedestrians, and the like. Further, the object identification information may include name, type, and location.

Table 2 is an example of HD map message information received through the V2X technology. The message information may include a variety of information in addition to the example of Table 2.

TABLE 2

| | |
|---|---|
| Traffic sign | Type |
| | Latitude |
| | Longitude |
| | Distance to traffic sign |

Host Vehicle LaneNum

In S220, the processor 470 determines whether the AHS is operable.

In S220, the processor 470 prioritizes the headlight control for preventing glare of a driver of a RV, and determines whether the leadlight radiates light toward an infrastructure. For example, when the headlight radiates light toward the infrastructure and causes glare of the driver of the RV, the processor 470 does not control operation of the AHS to radiate light of the headlight toward the infrastructure.

In S230, the processor 470 calculates a distance from a HV to the infrastructure on the basis of the HD map information received from the communication device 320. When a location of the infrastructure enters the radiation range of the headlight, the processor 470 control the operation of the AHS to radiate light of the headlight toward the infrastructure. The radiation range of the headlight may be set within a 25% range on the basis of the maximum radiation distance of the headlight. The processor 470 may illuminate the infrastructure (for example, traffic sign) by adjusting a radiation direction, the amount of light, and radiation range of a headlight during operating the AHS to increase visibility of a driver of the HV.

FIGS. 25 to 27 are views showing AHS operational control using infrastructure information of a HD Map according to an embodiment of the present disclosure.

The maximum radiation distance of a headlight may be vary from model to model. In the embodiment in FIGS. 25 to 27, it is assumed that the maximum radiation distance of the headlight is 400 m.

In FIG. 25, a distance between a HV and an infrastructure 60 is 500 m. The processor 470 does not operate the AHS for illuminating the infrastructure, since a location of the infrastructure is not in a radiation range of the headlight (over 400 m).

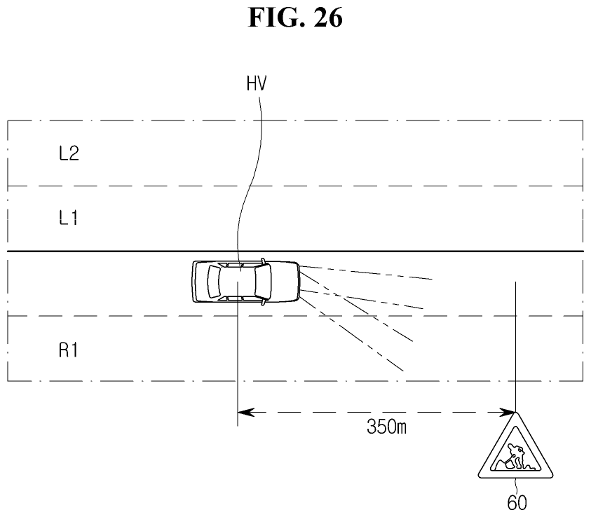

In FIG. 26, a distance between the HV and the infrastructure 60 is in the 25% range of 400 m that is the maximum radiation distance of the headlight (400 m˜300 m). The processor 470 operates the AHS for illuminating the infrastructure, since the location of the infrastructure is in the radiation range of the headlight (400 m˜300 m). In FIG. 26, the processor 470 controls the radiation direction of the headlight rightward for illuminating the infrastructure (traffic sign).

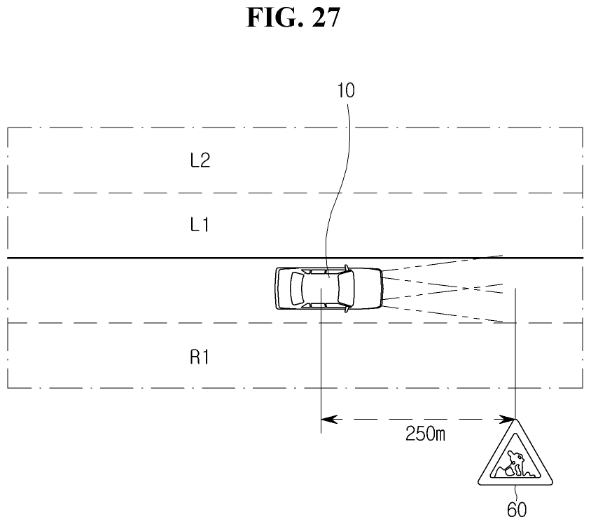

In FIG. 27, a distance between the HV and the infrastructure 60 is outside the 25% range of 400 m that is the maximum radiation distance of the headlight, so that the AHS is not operated to illuminate the infrastructure. When the distance between the HV and the infrastructure 60 is 250 m, even when the headlight is radiated toward the infrastructure, there is no difficulty for a driver of the HV to check the traffic infrastructure.

As described above, the present disclosure is configured such that the V2X is used to recognize a remote vehicle that is far away and is difficult to be recognized by using a sensor such as a camera, and the HD map is used to determine a driving path of the vehicle, so that the AHS can be operated optimally at a specific situation.

Further, the present disclosure is configured to receive infrastructure location information through the HD map, and operate the AHS when the location of the infrastructure enters the radiation range of the headlight to radiate light of the headlight toward the infrastructure, so that driver's visibility with respect to the infrastructure can be increased.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A control method for an adaptive headlight system (AHS) controlling a headlight of a vehicle, the control method comprising:
collecting driving information of a remote vehicle (RV) through V2X (vehicle to everything) communication; and
determining AHS operational condition,
wherein the AHS operational condition is a condition in which a present location of the RV is within an AHS operational range.

2. The control method of claim 1, wherein the AHS operational range is determined on the basis of a radiation range of a headlight mounted to a host vehicle (HV).

3. The control method of claim 1, wherein the AHS operational range is stored separately for each traffic lane in advance.

4. The control method of claim 3, wherein, in the determining the AHS operational condition, it is determined whether or not the present location of the RV is within the AHS operational range in response to a traffic lane where the RV is currently in.

5. The control method of claim 1, further comprising:
calculating a relative location of the RV by using a location of a host vehicle (HV) as a reference point.

6. The control method of claim 1, further comprising:
determining whether or not the RV drives in straight travelling.

7. The control method of claim 6, wherein authenticity of straight travelling of the RV is determined by checking an inclination value of each of coordinates in path history points of the RV.

8. The control method of claim 6, wherein authenticity of straight traveling of the RV is determined by checking a radius of curvature in path prediction information of the RV.

9. The control method of claim 1, further comprising:
determining whether or not the RV drives in an opposite direction to a host vehicle (HV).

10. The control method of claim 6, further comprising:
determining whether or not a location of the RV after a preset predetermined time is within the AHS operational range, when the RV does not drive in the straight travelling.

11. The control method of claim 10, further comprising:
determining whether or not the RV after the preset predetermined time drives in an opposite direction to a host vehicle (HV), when the location of the RV after the preset predetermined time is within the AHS operational range.

12. The control method of claim 1, further comprising:
receiving HD Map (high definition map) information; and
on the basis of the HD Map information, radiating light of a headlight of a host vehicle (HV) toward an infrastructure, when a location of the infrastructure enters a radiation range of the headlight.

13. An adaptive headlight system (AHS) controlling a headlight of a vehicle, the AHS comprising:
a headlight configured to radiate light toward front of the vehicle;
a communication device configured to collect driving information of a remote vehicle (RV); and
a processor configured to determine AHS operational condition,
wherein the AHS operational condition is a condition in which a present location of the RV is within an AHS operational range.

14. The AHS of claim 13, further comprising:
a memory in which the AHS operational range is stored,
wherein the AHS operational range stored in the memory is determined on the basis of a radiation range of the headlight mounted to a host vehicle (HV), and is stored separately for each traffic lane.

15. The AHS of claim 14, wherein the processor is configured to determine whether or not the present location of the RV is within the AHS operational range in response to a traffic lane where the RV is currently in.

16. The AHS of claim 13, wherein the processor is configured to calculate a relative location of the RV on the basis of a location of a host vehicle (HV).

17. The AHS of claim 13, wherein the processor is configured to determine whether or not the RV drives in straight travelling.

18. The AHS of claim 17, wherein the processor is configured to determine whether or not the RV drives in the straight traveling by checking an inclination value of each of coordinates in path history points of the RV.

19. The AHS of claim 17, wherein the processor is configured to determine whether or not the RV drives in the straight travelling by checking a radius of curvature in path prediction information of the RV.

20. The AHS of claim 13, wherein the processor is configured to determine whether or not the RV drives in an opposite direction to a host vehicle (HV).

21. The AHS of claim 17, wherein, when the RV is not in the straight travelling, the processor determines whether or not a location of the RV after a preset predetermined time is within the AHS operational range.

22. The AHS of claim 21, wherein, when the location of the RV after the preset predetermined time is within the AHS operational range, the processor determines whether or not the RV after the preset predetermined time drives in an opposite direction to a host vehicle (HV).

23. The AHS of claim 13, wherein the communication device is configured to receive HD Map (high definition map) information, and
on the basis of the HD Map information, the processor is configured to control light of the headlight of a host vehicle (HV) to be radiated toward an infrastructure, when a location of the infrastructure enters a radiation range of the headlight.

24. The AHS of claim 13, wherein the communication device is configured to exchange information with the RV on the basis of 5th generation mobile communication (5G).
